(19) United States
(12) Patent Application Publication
(10) Pub. No.: US 2024/0246409 A1
(43) Pub. Date: Jul. 25, 2024

(54) VEHICULAR CHARGE PORT COVER SYSTEM

(71) Applicant: Magna Mirrors of America, Inc., Holland, MI (US)

(72) Inventors: Marshall A. Zerbe, Decatur, MI (US); Andrew M. Neumann, Jenison, MI (US); Bryce A. Hilborn, Grand Rapids, MI (US); Connor G. Cervone, Byron Center, MI (US); Matthew V. Steffes, Grand Rapids, MI (US)

(21) Appl. No.: 18/419,751

(22) Filed: Jan. 23, 2024

Related U.S. Application Data
(60) Provisional application No. 63/497,454, filed on Apr. 21, 2023.
(60) Provisional application No. 63/481,503, filed on Jan. 25, 2023.

(51) Int. Cl. B60K 15/05

(52) U.S. Cl. CPC B60K 15/05; B60K 2015/0538

(57) ABSTRACT

A vehicular charge port closure system includes a cover panel and an actuator that is electrically operable to move the cover panel between a closed position and an opened position. The actuator includes a motor operable to drive an input gear of a gear train, an output element coupled to the cover panel and a clutch element coupled to the output element and to an output gear of the gear train. The output element moves together and in tandem with the cover panel. The motor, when operated, drives the input gear to drive the output gear and drive the clutch element to impart movement of the output element and the cover panel. The clutch element, when the cover panel is manually moved, decouples the output element from the output gear and manual movement of the cover panel does not impart movement of the gear train.

### CROSS REFERENCE TO RELATED APPLICATIONS

The present application claims the filing benefits of U.S. provisional application Ser. No. 63/497,454, filed Apr. 21, 2023, and U.S. provisional application Ser. No. 63/481,503, filed Jan. 25, 2023, which are hereby incorporated herein by reference in their entireties.

### FIELD OF THE INVENTION

The present invention relates to a charge port or fuel port of a vehicle.

### BACKGROUND OF THE INVENTION

It is known to cover or conceal a fuel port of a vehicle or a charging port of an electric vehicle with a flap or door that is pivotable relative to the port between a closed position, where the flap is disposed over the port to cover and conceal the port, and an opened position, where the flap is pivoted away from the port to expose the port for receiving a fuel source or electrical connector of a charging station. Commonly, the flap is located on the side of the vehicle and is manually pivotable between the closed and opened positions.

### SUMMARY OF THE INVENTION

A vehicular closure system for a charge port cover panel includes a cover panel disposed at a side of a vehicle equipped with the vehicular closure system. The cover panel is movable between (i) a closed position, where the cover panel conceals a charge port of the vehicle, and (ii) an opened position, where the cover panel is moved away from the charge port to allow access to a charging connector of the charge port. An actuator is electrically operable to move the cover panel between the closed position and the opened position. The actuator includes an electrically operable motor that, when electrically operated to move the cover panel between the closed position and the opened position, drives a gear train of the actuator. An output element of the actuator is coupled to the cover panel. The output element, as the cover panel moves between the closed position and the opened position, moves together and in tandem with the cover panel. The gear train of the actuator is coupled to the output element. The electrically operable motor, when the actuator is electrically operated, drives the gear train to impart movement of the output element and the cover panel. A clutch element is coupled between the output element and the gear train, and the clutch element, when the cover panel is manually moved between the closed position and the opened position, decouples the output element from the gear train. The output element, when the cover panel is manually moved and with the output element decoupled from the gear train, does not impart movement of the gear train.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular electric charging system;

FIGS. 2-5 are views of a charge port of the vehicular electric charging system, with a cover panel of the charge port in a closed position;

FIGS. 6-8 are views of the charge port of FIGS. 2-5, with the cover panel in an opened position;

FIG. 9 is an exploded view of the cover panel and linkage arms of the charge port of FIGS. 2-5;

FIGS. 10 and 11 are perspective views of another charge port, with a cover panel of the charge port in an opened position;

FIGS. 12-14 are perspective views of the charge port of FIGS. 10 and 11, with the cover panel in the closed position;

FIGS. 15 and 16 are perspective views of the charge port of FIGS. 10 and 11, with the cover panel in the opened position and flexible sheets of material extending between the cover panel and the mounting base along opposing sides of the charge port;

FIG. 17 is a perspective view of another charge port, with a cover panel of the charge port in the opened position;

FIGS. 18-20 are views of the charge port of FIG. 17, with the cover panel in the opened position;

FIGS. 21-23 are views of the actuator assembly and cover panel of the charge port of FIG. 17, with the cover panel in the opened position;

FIGS. 24 and 25 are views of the charge port of FIG. 17, with the cover panel in the closed position;

FIG. 26 is a perspective view of the actuator assembly of the charge port of FIG. 17, with an arcuate gear element extended relative to the actuator;

FIGS. 27-33 are views of the actuator assembly of FIG. 26, with the arcuate gear element retracted relative to the actuator;

FIG. 34 is a perspective view of the charge port of FIG. 17, with the cover panel in the closed position;

FIG. 35 is another perspective view of the charge port of FIG. 17, with the cover panel in the opened position;

FIG. 36 is another perspective view of the actuator assembly of FIG. 26;

FIG. 37 is an exploded view of the actuator assembly of FIG. 26;

FIG. 38 is a perspective view of another charge port, with inner cover panels and outer cover panels of the charge port in an opened position;

FIG. 39 is another perspective view of the charge port of FIG. 38, showing an actuator assembly disposed at a mounting base of the charge port;

FIG. 40 is a perspective view of the actuator assembly of FIG. 39;

FIG. 41 is a perspective view of a permanent gear and a friction gear of the actuator assembly of FIG. 39;

FIG. 42 is a partial perspective view of the actuator assembly and the inner and outer cover panels of the charge port of FIG. 39;

FIG. 43 is an exploded view of the charge port of FIG. 38;

FIGS. 44 and 45 are perspective views of another charge port, with a cover panel of the charge port in a closed position;

FIGS. 46 and 47 are perspective views of the charge port of FIGS. 44 and 45, with the cover panel in an opened position;

FIG. 48 is a perspective view of an actuator assembly of another charge port;

FIGS. 49-55 are views of the actuator assembly of FIG. 48;

FIG. 56 is a plan view of the actuator assembly of FIG. 48, with a housing portion removed to show the motor and gear train of the actuator assembly;

FIGS. 57-59 are views of a lead screw and a lead nut of the actuator assembly of FIG. 48;

FIG. 60 is a sectional view of the lead screw and lead nut of the actuator assembly of FIG. 48;

FIGS. 61-63 are exploded views of the actuator assembly of FIG. 48;

FIG. 64 is a sectional view of the actuator assembly of FIG. 48;

FIG. 65 is a perspective view of the lead nut of the actuator assembly of FIG. 48, where a guide channel formed along the lead nut is configured to guide linear movement of the lead nut and cover panel along an axis inward from the side of the vehicle and pivotal movement of the lead nut and cover panel about the axis relative to the side of the vehicle;

FIG. 66 is a perspective view of a housing portion of the actuator assembly of FIG. 48;

FIG. 67 is a perspective view of another lead nut of the actuator assembly of FIG. 48, where the guide channel formed along the lead nut is configured to guide linear movement of the lead nut and cover panel along the axis outward from the side of the vehicle and pivotal movement of the lead nut and cover panel about the axis relative to the side of the vehicle;

FIGS. 68 and 69 are perspective views of the actuator assembly of FIG. 48, with the lead screw coupled to the cover panel;

FIGS. 70 and 71 are exploded views of the actuator assembly of FIG. 48 and the cover panel;

FIGS. 71A-71D depict the charge port with the actuator assembly of FIG. 48 as the cover panel moves from a closed position linearly inward from the side of the vehicle and pivots relative to the side of the vehicle toward an opened position;

FIGS. 72A-72D depict linear travel of the lead nut of FIG. 65 relative to the housing portion of the actuator assembly as the cover panel moves between the closed position and the opened position;

FIGS. 72E-72H depict pivotal travel of the lead nut of FIG. 65 relative to the housing portion of the actuator assembly as the cover panel moves between the closed position and the opened position; and

FIG. 73A-73D depict the charge port with the actuator assembly of FIG. 48 as the cover panel moves from a closed position linearly outward from the side of the vehicle and pivots relative to the side of the vehicle toward an opened position.

### DESCRIPTION OF THE PREFERRED EMBODIMENTS

A vehicular electric charging charge port opening system operates to open and/or close a power charge flap or panel of an electrically powered vehicle that covers a charging connector configured to electrically connect with an electrical connector of a charging wand to charge batteries of the electrically powered vehicle. Aspects of the power charge flap described herein may be suitable for use with a fuel port cover for covering a fuel filler port or opening of a vehicle that is configured to receive a nozzle that delivers fuel (e.g., gasoline) to a fuel tank of the vehicle via the fuel port.

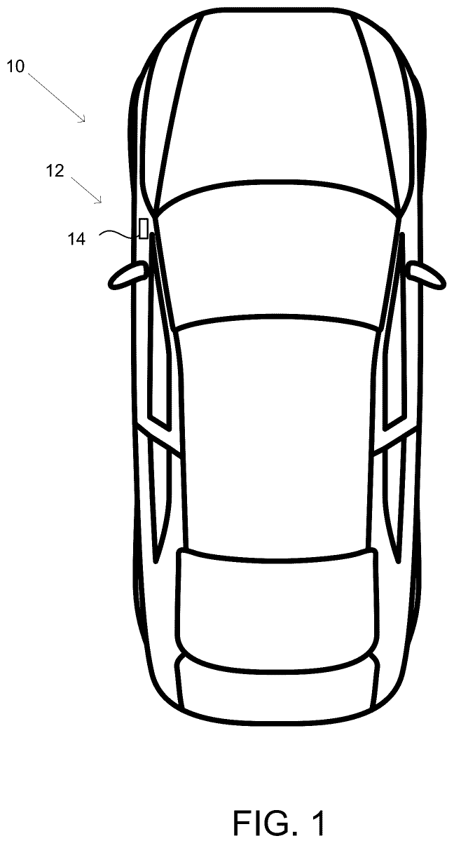

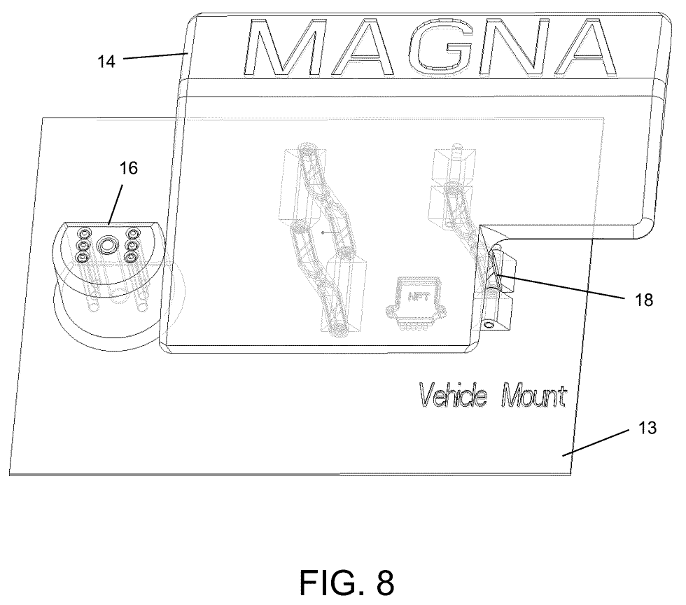

Referring now to FIGS. 1-9, a vehicle 10 (e.g., an electric vehicle or EV, or a plug-in hybrid vehicle or PHEV) includes an electrical charging system or charge port 12 at a side of the vehicle 10, where the charge port 12 includes a base portion 13 and a cover panel or flap 14 (such as a panel that is pivotably mounted at the vehicle or the base portion and that has an outer surface that, when the panel is in the closed position, corresponds with and/or is substantially flush with an outer surface of the exterior panel(s) of the vehicle at and around the charge port of the vehicle). The cover panel 14, when in a closed position, conceals a charging connector 16 of the charge port 12 that is configured to electrically connect with an electrical connector or charging wand (not shown) of a charging station or system to charge batteries of the vehicle 10. When in an open position, the cover panel 14 is moved at least partially away from the charging connector 16 to reveal the charging connector 16 such that the electrical connector of the charging wand (that is electrically connected to the charging station or system and that is configured for electrically connecting to or plugging into the charging connector of the vehicle) can electrically connect to the charging connector 16.

As shown in FIG. 1, the charge port 12 is disposed along a side of the vehicle 10 and, when the flap 14 is in the closed position, the exterior surface of the flap 14 is substantially flush with and corresponds to the exterior surface of the vehicle 10 at or surrounding the charge port 12. The charge port 12 may be disposed at any suitable position at the exterior of the vehicle. For example, the charge port 12 may be disposed at the front or rear fender or bumper of the vehicle. Optionally, the charge port 12 may be concealed behind an exterior feature of the vehicle 10, such as a manufacturers emblem, a portion of a headlight or taillight, a license plate bracket, or the like, where the closure system enables movement of the exterior feature between the closed position and the opened position.

When the cover panel 14 is in the closed position, the cover panel 14 may at least partially compress a sealing element or gasket between a rear or interior side or an edge region of the cover panel 14 and the base portion 13 or side of the vehicle 10 surrounding the charge port 12 to protect the connector portion and limit or preclude moisture and contaminants from entering the charge port 12 when the cover panel 14 is closed. For example, the sealing element may be disposed at the interior side of the cover panel 14 or at the base portion 13 and configured to at least partially circumscribe the connector when the cover panel 14 is closed.

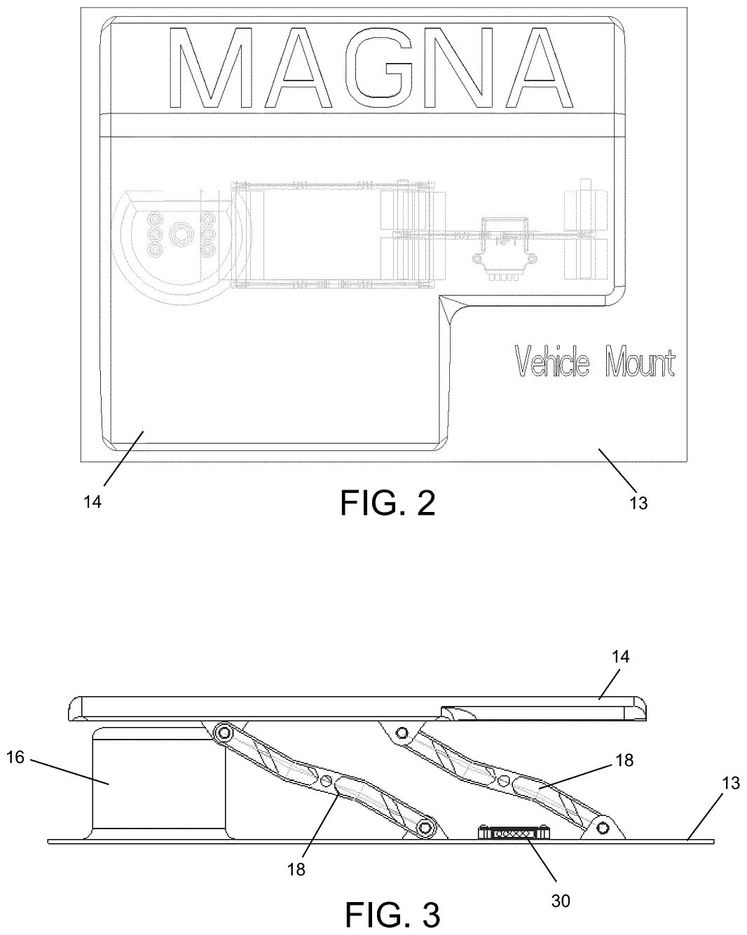

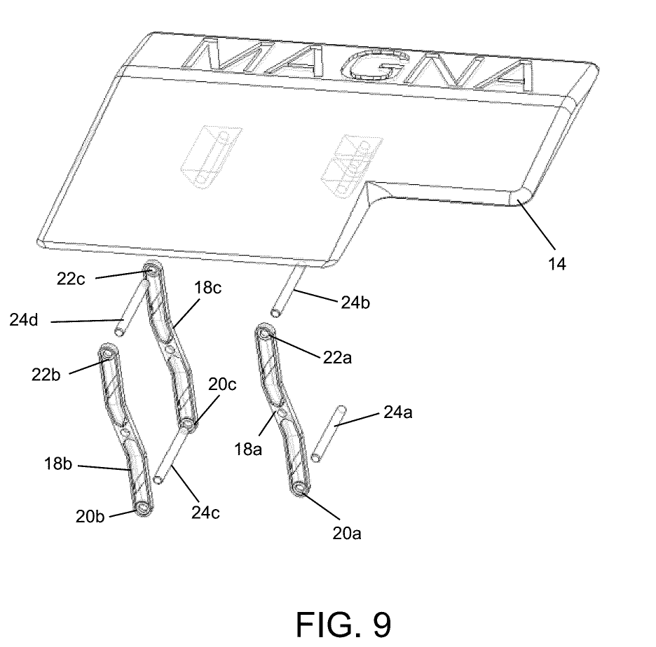

In the illustrated example of FIGS. 2-9, the cover panel 14 is pivotably attached at the bracket or base portion 13 via one or more hinge arms or bars 18 (e.g., two or more hinge arms, three or more hinge arms, four or more hinge arms, and the like) that pivot relative to the base portion 13 to move the cover panel 14 between the closed position and the opened position. Each hinge arm 18 includes a first end 20 that is pivotably attached at the base portion 13 and an opposite second end 22 that is pivotably attached at the cover panel 14. For example, respective pivot pins 24 may extend through the first and second ends of the hinge arms 18 and attaching portions or mounting structure of the cover panel 14 and base portion 13. As shown in FIG. 9, the charge port 12 has a three-bar mounting structure, where a first pivot pin 24a pivotably attaches the first end 20a of a first hinge arm 18a at the base portion 13 and a second pivot pin 24b pivotably attaches the second end 22a of the first hinge arm 18a at the cover panel 14. A third pivot pin 24c extends between the first end 20b of a second hinge arm 18b and the first end 20c of a third hinge arm 18c and pivotably attaches the second and third hinge arms at the base portion 13. Similarly, a fourth pivot pin 24d extends between the second end 22b of the second hinge arm 18b and the second end 22c of the third hinge arm 18c and pivotably attaches the second and third hinge arms at the cover panel 14. Thus, the pivot pins 24 define parallel pivot axes for the charge port 12, with the hinge arms 18 pivoting relative to the base portion 13 via the pivot pins 24 at the respective first ends of the hinge arms 18 and the cover panel 14 pivoting relative to the hinge arms 18 via the pivot pins at the respective second ends of the hinge arms 18.

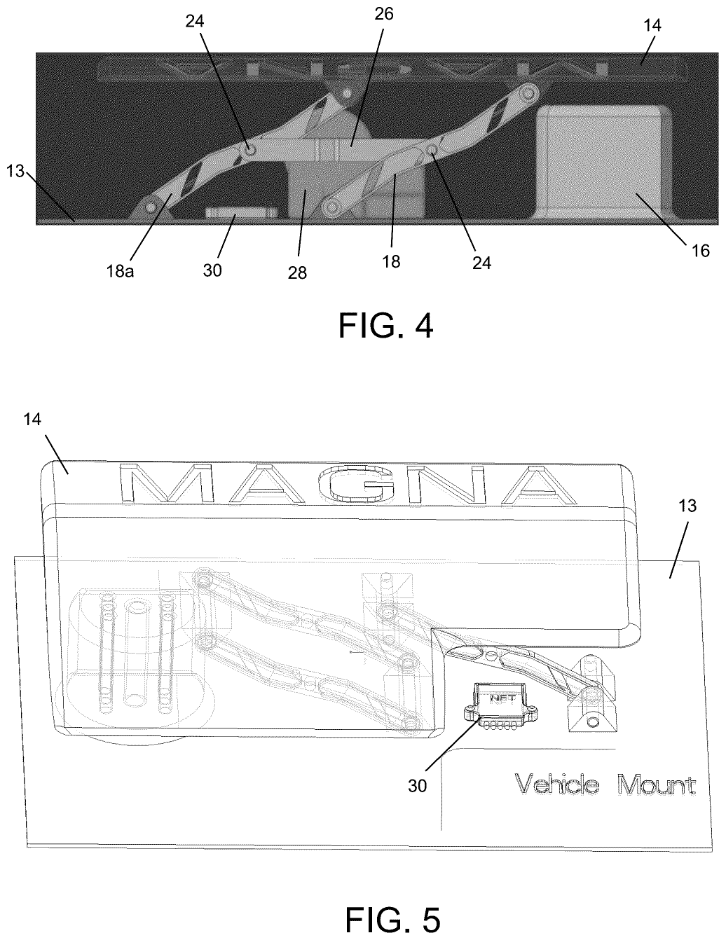

A connecting arm 26 may connect the first hinge arm 18a and the second and third hinge arms so that the hinge arms collectively pivot relative to the base portion 13 together and in tandem with one another in a swinging or arcuate motion (FIG. 4). For example, a first end of the connecting arm 26 is pivotably connected at the first hinge arm 18a between the first and second ends of the hinge arm (such as via a pivot pin 24) and a second end of the connecting arm 26 is pivotably connected at a pivot pin 24 extending between the second and third hinge arms. Thus, the charge port 12 may have a four-bar mounting structure.

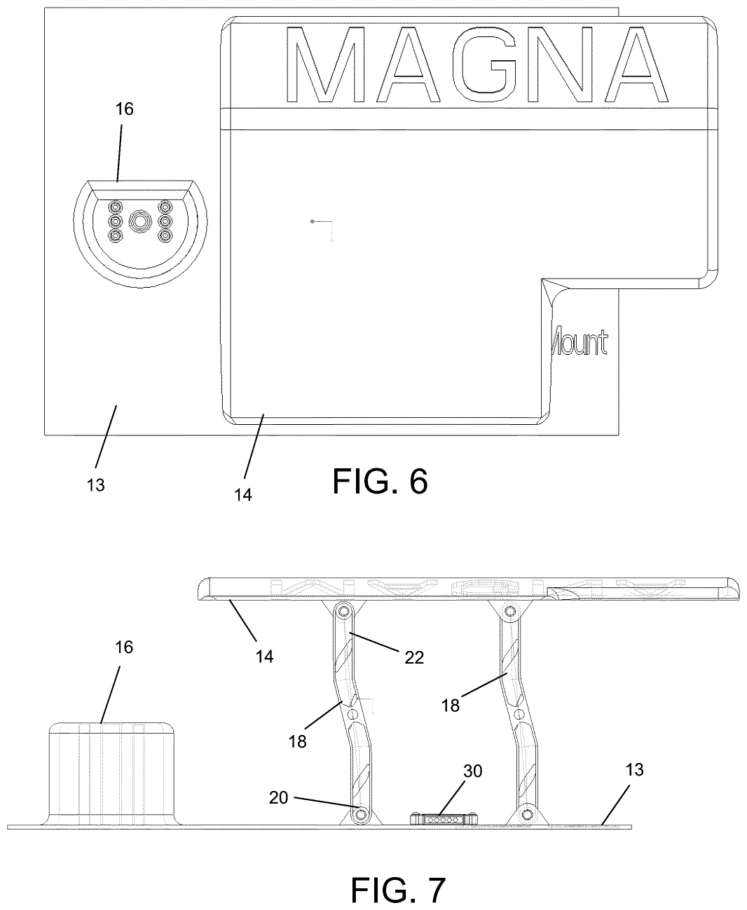

The charging port or system 12, when the cover panel 14 is closed (FIGS. 2-5), provides a panel 14 having an outer surface that generally corresponds with and/or is generally flush with the side or front or rear portion or panel of the vehicle at which the charging port is disposed. To charge the electric vehicle 10, the cover panel 14 is opened (FIGS. 6-8) and the charging connector 16 is positioned such that a receiving portion or connecting port or socket is accessible by the charging wand. That is, the charging connector 16, via a receiving portion, is configured to mate with the charging wand to deliver power from the charging wand to the battery system of the vehicle to charge the vehicle batteries. When the cover panel 14 is in the closed position, the connector 16 is recessed at the side of the vehicle and the cover panel 14 is disposed over the connector 16 to protect and conceal the connector 16 from view. When the cover panel 14 is moved from the closed position to the open position, the connector 16 and receiving portion are at least partially exposed at the exterior of the vehicle to be accessible for receiving the charging wand.

When the cover panel 14 moves from the closed position (FIG. 3) toward the opened position (FIG. 7), the cover panel 14 moves along an arcuate or swing path of motion according to pivoting of the hinge arms 18 relative to the base portion 13. The cover panel 14 swings at least partially outward from the side of the vehicle and at least partially sideward (or optionally upward or downward) along the side of the vehicle relative to the connector 16 to allow access to the charging connector 16 for connecting the charging wand.

The charge port 12 may comprise a charge port assembly or module that includes the charging connector 16 and the cover panel 14 mounted (e.g., pivotably mounted) at the base portion 13 and that is configured to be mounted at the vehicle 10. The mounting bracket or base portion 13 thus may be attached to or mounted at the vehicle 10, and the charging connector 16 may be electrically connected to a charging wire or cable of the vehicle 10 so that, when the charging wand is connected to the charging connector 16, the charging wand electrically charges the vehicle battery. The base portion 13 is fixedly mounted at the vehicle 10 so that the cover panel 14 may move or pivot relative to the base portion 13 to open and close relative to the side (or front or rear) of the vehicle 10 at which the base portion 13 is mounted. The cover panel 14 may pivot relative to the panel of the vehicle about any suitably oriented pivot axis, such as a horizontal pivot axis or a vertical pivot axis. Thus, the charge port 12 may be implemented in a range of vehicle body styles at any suitable mounting position.

As shown in FIG. 4, the charge port 12 may include one or more motors or actuators 28 that cause the movement of the cover panel 14 relative to the base portion 13, such as responsive to a user input. For example, the actuator 28 may be mechanically coupled to one or more of the hinge arms 18 and may impart movement of the cover panel 14 between the closed position and the opened position by pivoting the one or more hinge arms 18 relative to the base portion 13. Movement of the one or more hinge arms 18 may impart movement of the cover panel 14 and additional hinge arms not directly coupled to the actuator 28. The actuator 28 may be configured to deploy the cover panel 14 through ice build-up at the exterior surface of the cover panel 14 by providing sufficient actuating force when moving the cover panel 14 from the closed position toward the opened position. For example, the actuator 28 of the charge port 12 may be configured to provide force of 100 Newtons or more, 150 Newtons or more, 250 Newtons or more, and the like to achieve a minimum or worst-case deployment distance. The system may utilize a rotational actuator to produce the torque.

The charge port 12 may actuate in response to a user input such as the user pushing a button, the user making direct contact with the cover panel 14, sensing of presence or movement of the user or user's hand at or near the charge port 12, or a user application communicating with the vehicle and/or charge port system via a wireless technology such as BLUETOOTH™, near-field communications (NFC), Wi-Fi™ and the like.

For example, and as shown in FIGS. 4, 5, and 7, a near-field transmitter (NFT) device 30 may be disposed at the charge port 12, such as mounted at or integrated with the base portion 13 and disposed behind the cover panel 14, for communication with a user device. When the NFT device 30 communicates with a user device (such as a mobile device or key fob or cellphone) that is within range of the NFT device 30 and verifies that the user device is authorized or associated with the vehicle, the actuator 28 moves the cover panel 14 between the closed position and the opened position, such as to provide access to the connector 16.

Optionally, the charge port 12 may include one or more sensors (e.g., imaging sensors or ultrasonic sensors or radar sensors or touch or proximity sensors) that sense presence and/or movement of the user's hand at or near the charge port 12, whereby the actuator(s) may move or pivot the cover panel 14 responsive to detecting presence of the person's hand or responsive to determining a gesture or movement of the person's hand at or near the charge port.

Thus, the charge port 12 provides an automatically opening charge port cover that may recognize an approaching user (such as via an integrated NFC device) and transmits force to deploy through ice build-up. The charging door is actuator driven and opens in an arc motion. The system provides a three-bar or four-bar linkage system that may be adjusted for different platforms and applications to provide parallel deployment and retract sweeps. Thus, the system puts forth a different solution than a single pivot manual open system.

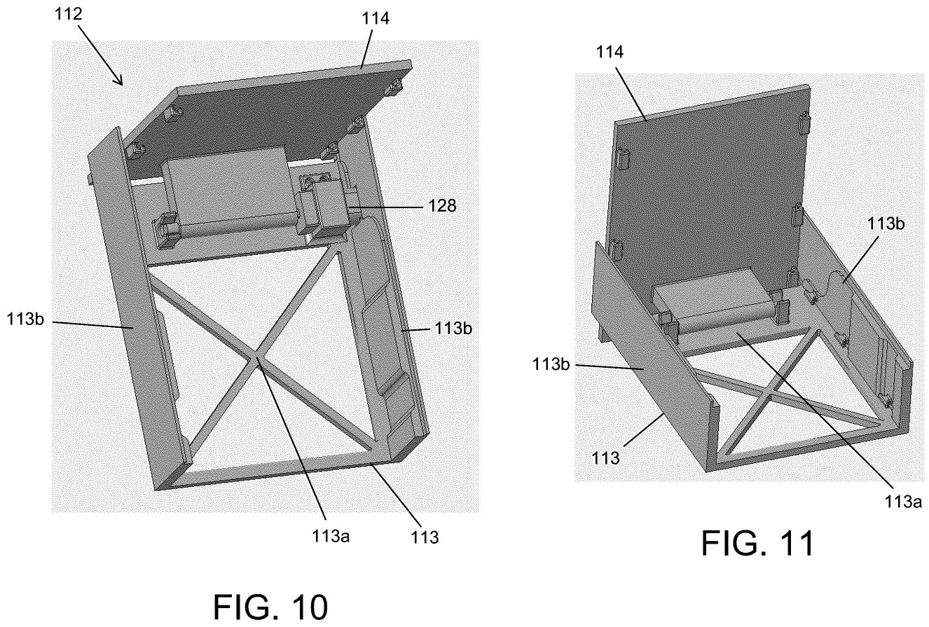

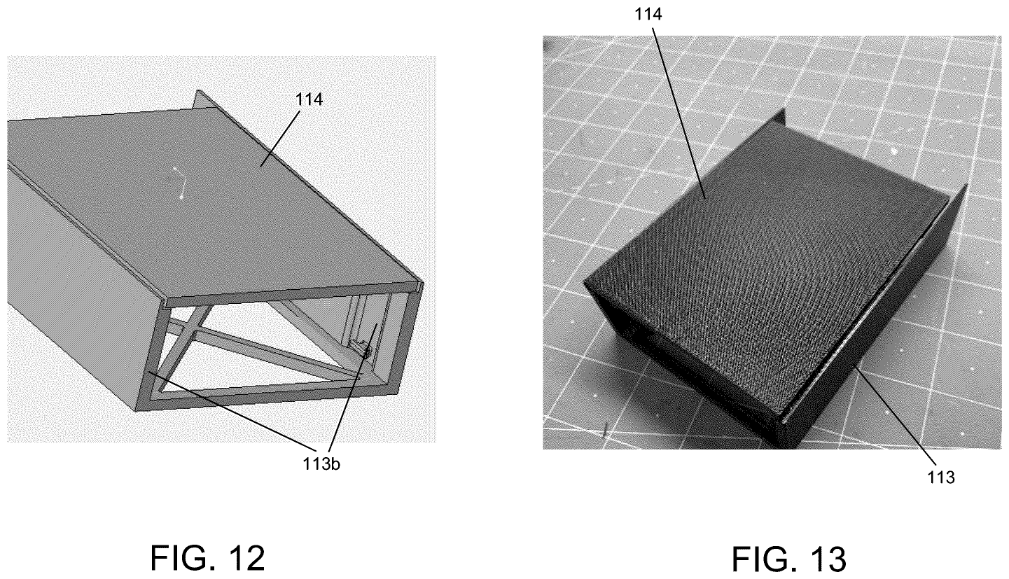

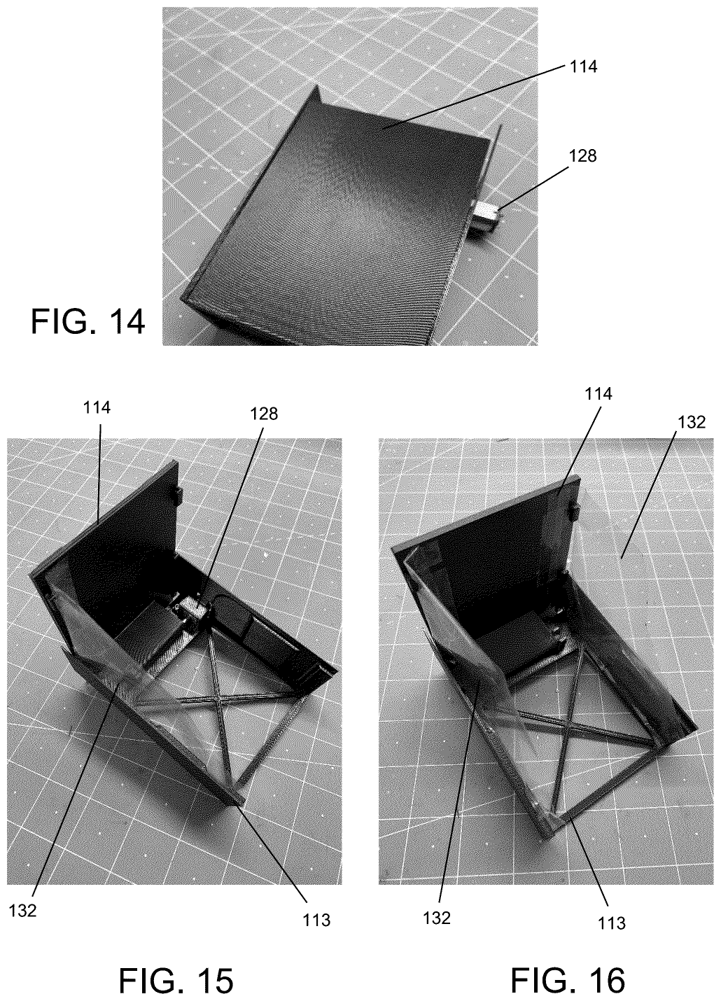

Optionally, the base portion of the charge port system may be at least partially recessed from the outer body panel of the vehicle. For example, and referring to FIGS. 10-16, a charge port 112 may include a base portion or mounting bracket 113 that is recessed from the side of the vehicle to protect the charging connector and connected charging wand from contaminants and moisture, such as dirt, dust, snow, ice and rain. A cover panel 114 is pivotably mounted relative to the base portion 113 and pivots relative to the base portion 113 about a horizontal pivot axis (that may extend generally parallel to a longitudinal axis of the vehicle) so that the cover panel 114 vertically deploys to be disposed in the opened position at least partially over and above the charging connector and charging wand while they vehicle is being charged. An actuator 128 may be mechanically coupled to the cover panel 114 to pivot the cover panel 114 between the closed position (FIGS. 12 and 13) and the opened position (FIGS. 10 and 11).

The base portion 113 includes an inner panel or portion 113a that is recessed from the exterior surface or body panel of the vehicle and the charging connector may be disposed at or coupled to the inner panel 113a of the base portion 113. A housing or frame or sidewalls 113b extend from the inner panel 113a and toward the body panel of the vehicle. The sidewalls 113b (together with the cover panel 114 in the opened position) are formed to at least partially surround the charging connector and the charging wand when the charging wand is mated to the charging connector and during the charging process. With the cover panel 114 in the opened position, the cover panel 114 may be received at least partially within the side of the vehicle and extend along a portion of the sidewalls 113b of the base portion 113. Another portion of the opened cover panel 114 extends outward from the side of the vehicle and over and above the base portion 113 and charging connector. The cover panel 114 may be pivotably connected to the inner panel 113a of the base portion 113.

With the cover panel 114 in the closed position, the cover panel 114 extends along an upper end region of the sidewalls 113b opposite a lower end region coupled to the inner panel 113a. For example, the cover panel 114 may be received in a lip or sealing portion of the sidewalls 113b to seal the charge port 112 when the cover panel 114 is in the closed position.

As shown in FIGS. 15 and 16, the charge port 112 may include flexible and weather resistant flaps or sheets of material 132 coupled between the cover panel 114 and the sidewalls 113b of the base portion 113. When the cover panel 114 is closed, the flaps 132 fold and store within the charge port between the cover panel 114 and the inner panel 113a. When the cover panel 114 is opened, the flaps 132 stretch or expand along opposing sides of the charge port 112 between the cover panel 114 and the base portion 113 to provide protection from contaminants and moisture. The flaps 132 comprise a weatherproof or water resistant and durable material, such as a nylon ripstop material or plastic sheath. The flaps 132 may comprise an accordion construction for easier folding and expansion when the cover panel 114 is moved between the closed position and the opened position.

That is, the charge port has a material connected to both the door or panel and the housing or base portion. This creates a larger area of protection. Additionally, the charge port does not need to drop down (i.e., pivot partially from the opened position toward the closed position) after the charge gun or wand is inserted to protect the charge port. The weatherproofing material may include plastic (e.g., clear or transparent plastic), nylon ripstop fabric, and the like to provide a strong weatherproofing.

Because of the lightweight and compact design, the charge port precludes the ingress of snow, water, and other weather and contaminants to the vehicle's charge port. The charge port provides protection while allowing the door to stay open to allow a user to view the status of the charge port connection. The charge port is integrated with the vehicle and there is no need for extra attachments or parts.

The panel seals the charge port when the panel is closed and keeps water and snow off of the charge port and charge gun while the vehicle is being charged. The charge panel is operable to manually open and close the panel and power open and close the panel. The charge port protects the charge port from snow and other weather, has a compact shape, and a vertical deployment.

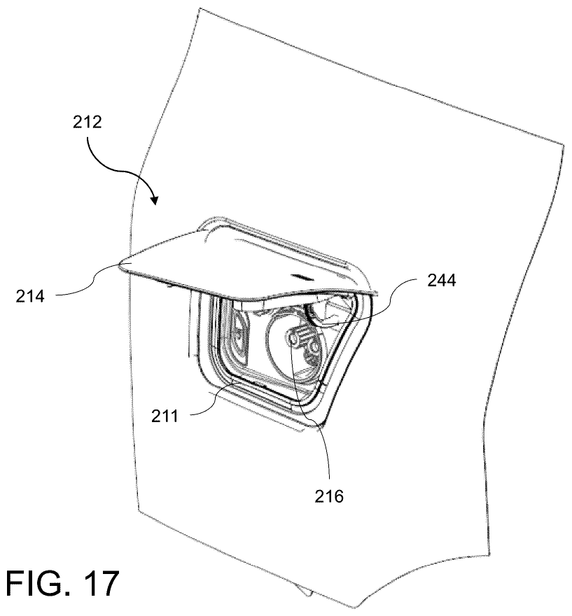

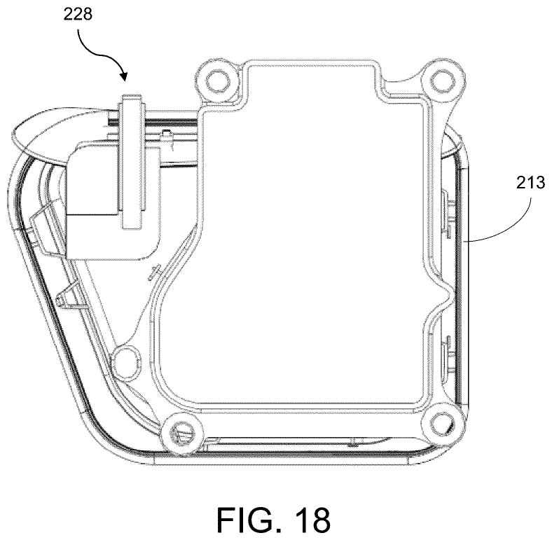

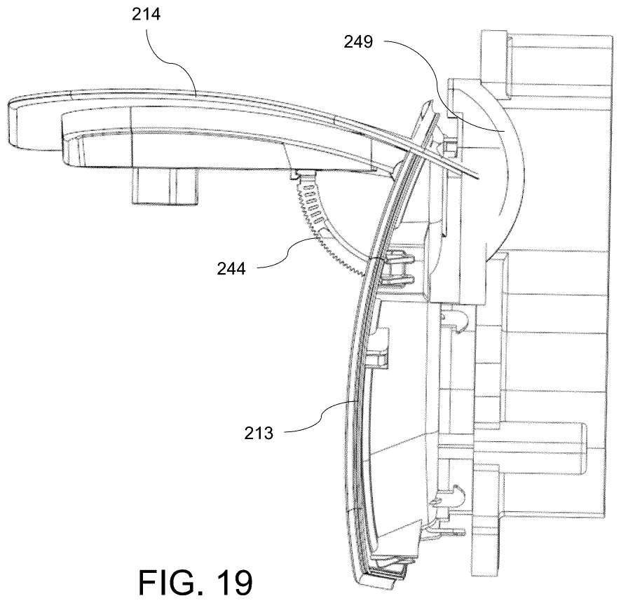

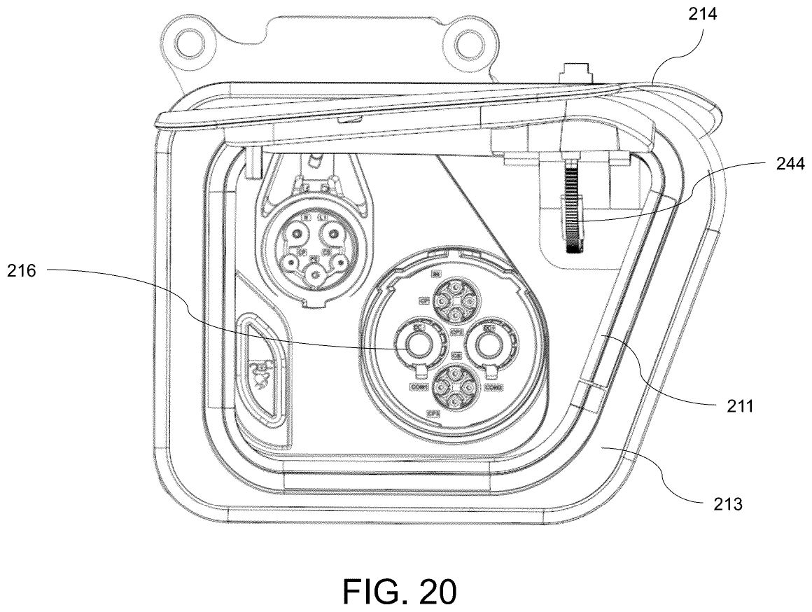

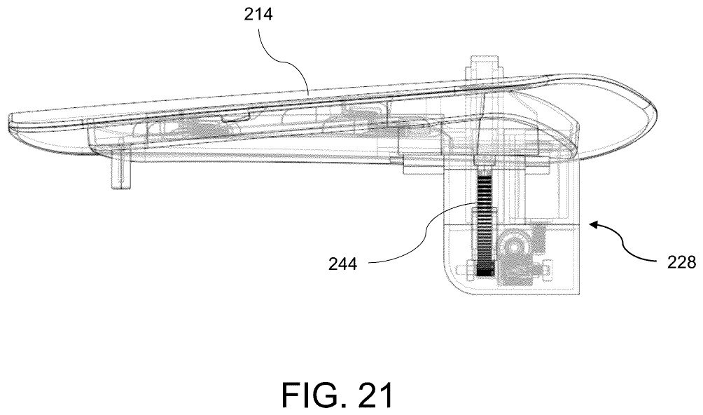

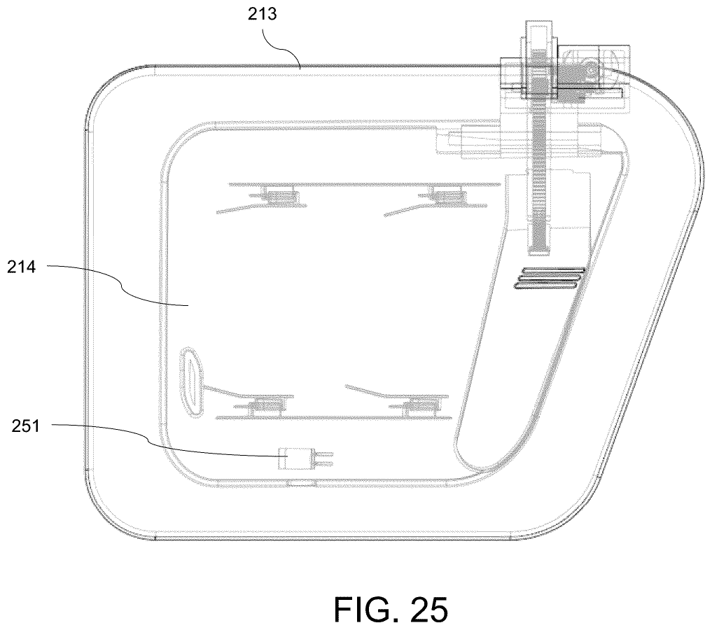

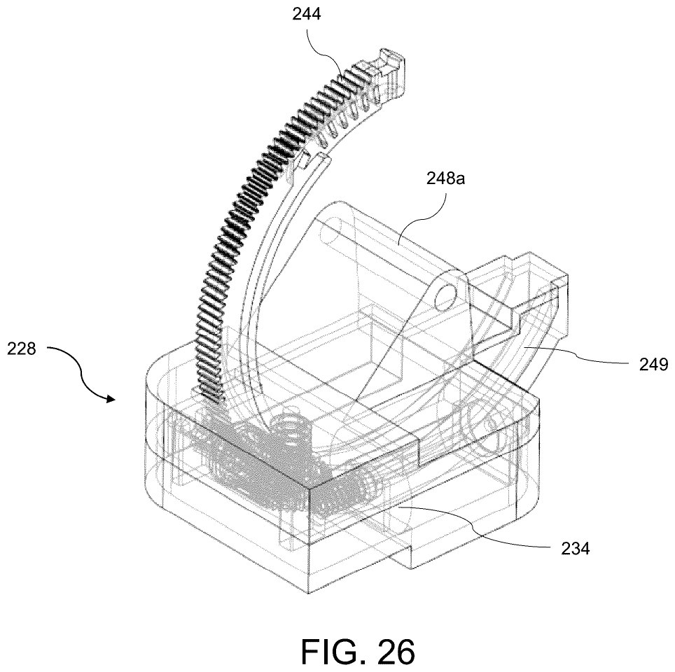

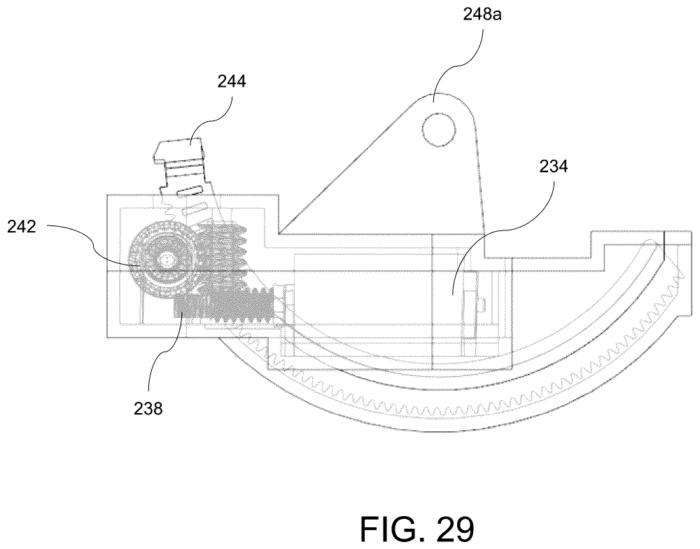

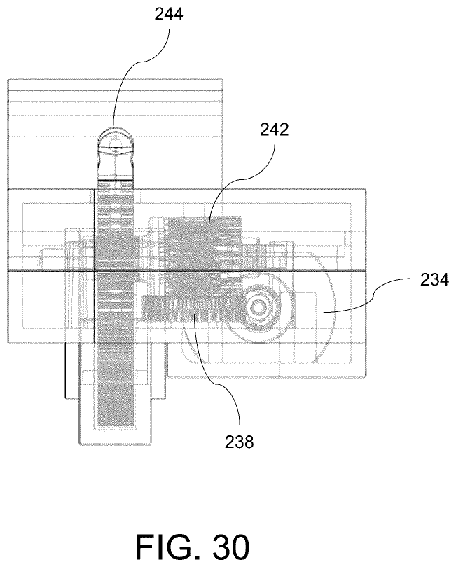

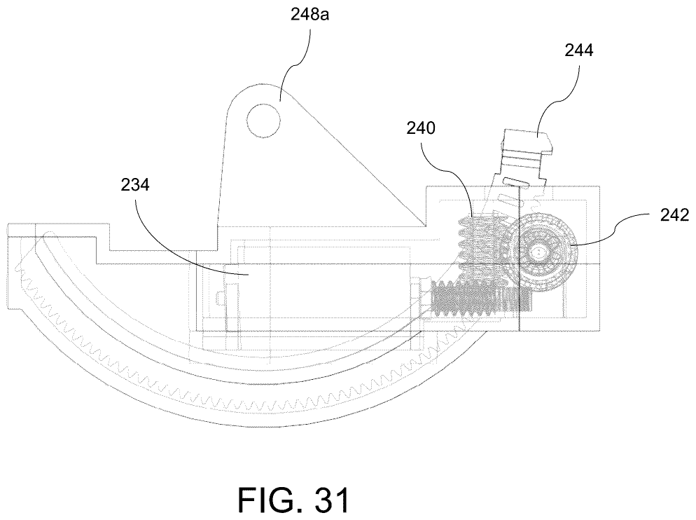

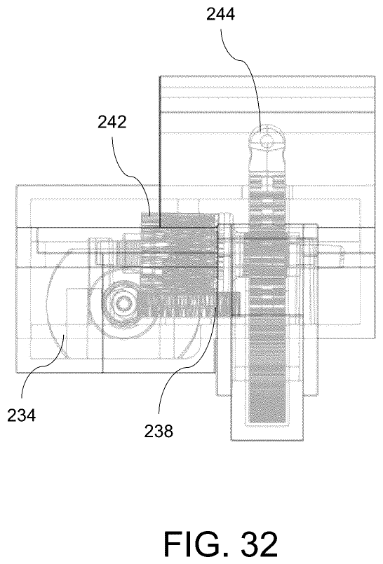

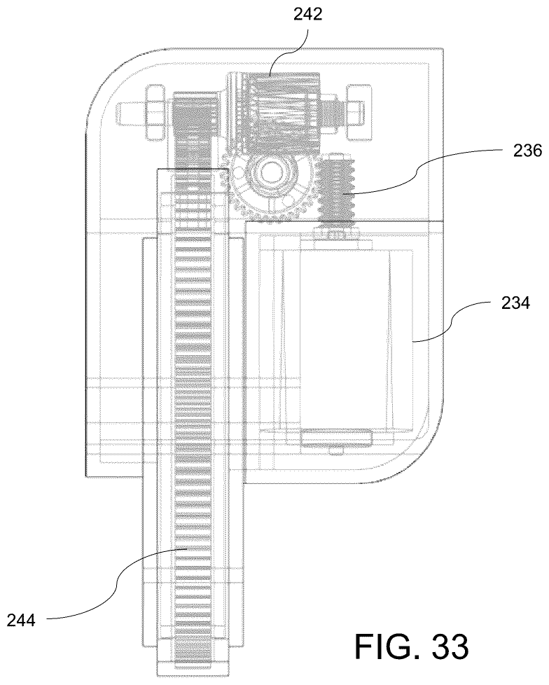

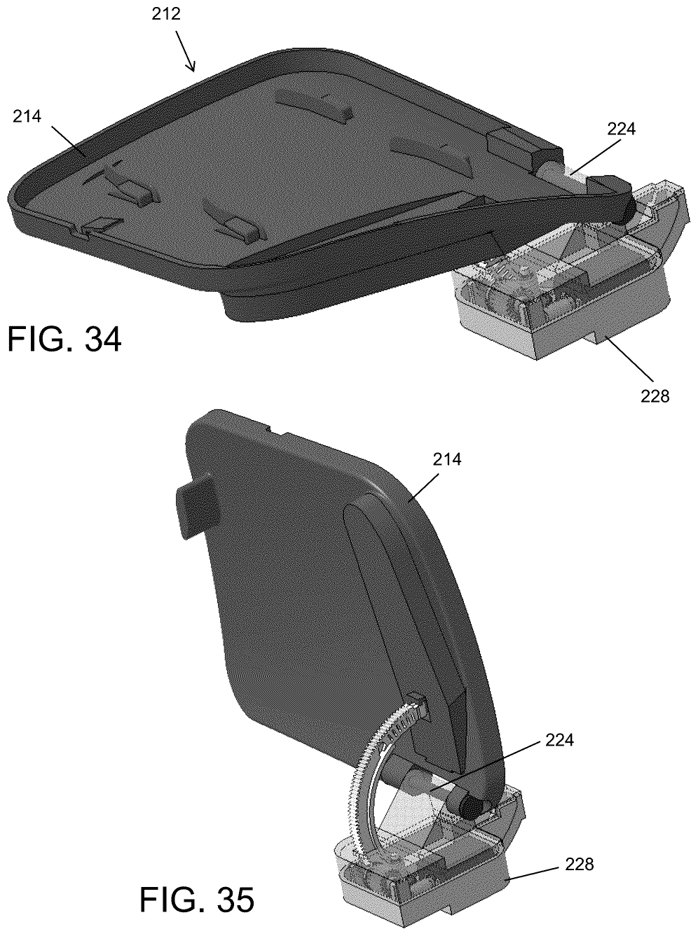

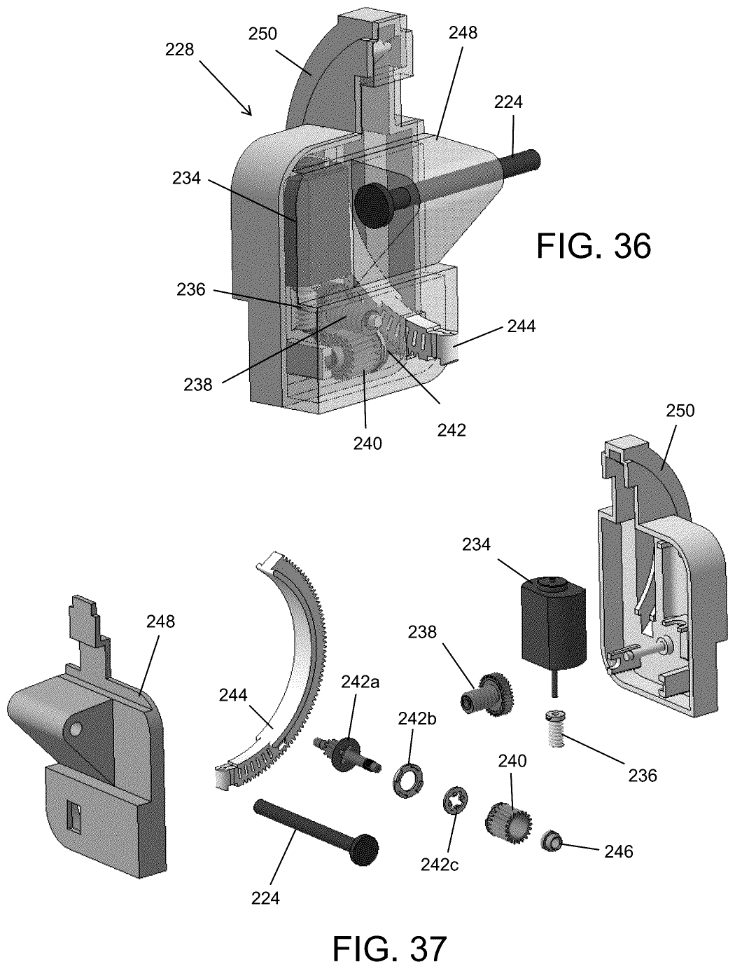

Optionally, the charge port may include an actuator that drives an output element coupled to the cover panel for moving the cover panel between the closed position and the opened position. For example, and referring to FIGS. 17-37, a charge port 212 may include a cover panel 214 that is pivotably connected to the base portion 213 via a hinge pin or pivot pin 224 and that is pivotable relative to the base portion 213 between the opened position (FIG. 17) and the closed position (FIG. 25) via an actuator assembly 228. The pivot pin 224 defines the pivot axis of the cover panel 214 and the cover panel 214 may pivot in any suitable direction outward from the base portion (e.g., sideward and along the side of the vehicle, upward and outward from the vehicle, downward and outward from the vehicle, and the like). In the illustrated example, the cover panel 214 pivots along a horizontal pivot axis (that may extend generally parallel to a longitudinal axis of the vehicle) such that, when the cover panel 214 moves from the closed position toward the opened position, the cover panel 214 pivots upward and outward from the side of the vehicle (e.g., clockwise in FIG. 19). The pivot pin 224 may extend through the cover panel 214 and a receiving tab 248a of the actuator housing or the base portion 213 to pivotably attach the cover panel 214 at the base portion 213.

A sealing element or gasket 211 is disposed at the base portion 213 so that, when the cover panel 214 is in the closed position, the cover panel 214 at least partially compresses the sealing element 211 between the cover panel 214 and the base portion 213 and limits or precludes moisture and contaminants from entering the charge port and causing damage to the charging connector 216. The sealing element 211 at least partially circumscribes the charging connector 216 at the base portion 213.

The actuator assembly 228 may be fixed relative to the base portion and engage the cover panel 214 and/or the pivot pin 224 to pivot the cover panel 214 relative to the base portion. For example, the actuator 228 is mounted along an upper edge region of the base portion 213 and is coupled to an inner side or surface of the cover panel 214 at or near the pivot pin 224 along an upper edge and/or corner region of the cover panel 214. Because the actuator 228 and the pivot pin 224 couple to the cover panel 214 along an edge and/or corner region of the cover panel 214, the actuator 228 includes a stability arm 244 that supports the cover panel 214. As discussed further below, the stability arm 244 may comprise an arcuate gear element or rocker arm 244 that is driven by the actuator 228 to move the cover panel 214 between the closed position and the opened position.

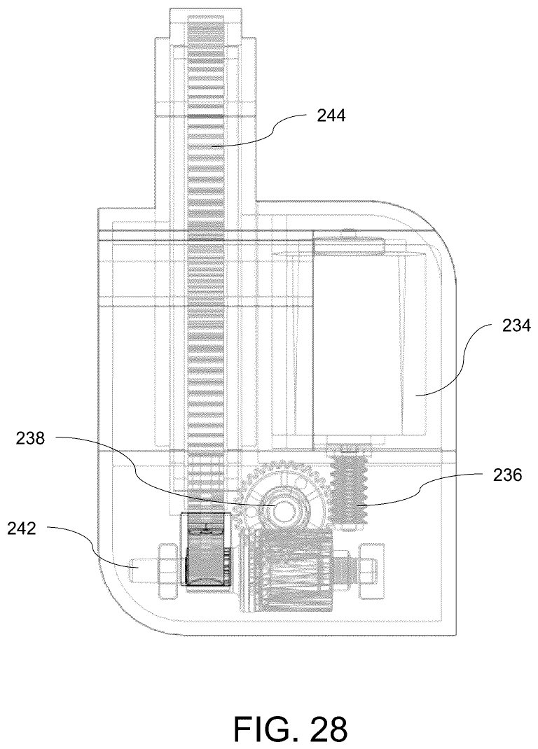

As shown in FIGS. 28-33, 36 and 37, the actuator assembly 228 includes an electrically operable motor 234 that, when the actuator is electrically operated to move the cover panel 214 between the opened position and the closed position, rotatably drives a worm gear 236 coupled to the motor 234. The worm gear 236 rotatably drives a first gear or combo gear 238 of a gear train of the actuator assembly 228 which in turn drives a second gear or helical gear 240 of the gear train. The second gear 240 is coupled to a clutch assembly or clutch element 242 that engages the arcuate gear element or rocker arm 244. The rocker arm 244 is coupled to the cover panel 214 so that, when the motor 234 is operated and drives the gear train, the clutch assembly 242 rotates and travels along the rocker arm 244 to move the rocker arm 244 relative to the actuator assembly 228 and pivot the cover panel 214 relative to the base portion.

The clutch assembly 242 is configured to slip relative to the gear train of the actuator assembly 228, such as when a load is disposed at the cover panel that prevents the cover panel 214 from opening or when the cover panel 214 is manually moved between the opened position and the closed position, to prevent damage to the motor 234. For example, the clutch assembly 242 may include a clutch shaft 242a with a gear element that engages the rocker arm 244 (FIG. 37). The clutch shaft 242a includes a portion that extends along the helical gear 240 and is axially coupled to the helical gear 240 via a crimp washer 246. A first clutch pad or disc 242b and a second clutch pad or disc 242c are disposed along the clutch shaft 242a between the end that engages the rocker arm 244 and the helical gear 240. The first clutch disc 242b may be rotationally fixed to the clutch shaft 242a and the second clutch disc 242c may be rotationally fixed to the helical gear 240 so that frictional engagement between the clutch discs allows the helical gear 240 to impart movement of the clutch assembly 242 and rocker arm 244 when the motor 234 is operated. When a torque load at the cover panel 214 overcomes the frictional force between the clutch discs (such as when ice build-up is present at the cover panel), the clutch discs slip relative to one another and the helical gear 240 pivots relative to the clutch assembly 242 without rotating the helical gear 240. Similarly, when the cover panel 214 is manually moved between the closed position and the opened position, the torque may overcome the frictional force between the clutch discs and the clutch assembly 242 may pivot relative to the helical gear 240 without imparting movement of the helical gear 240.

The electrically operable motor 234, gear train, clutch assembly 242, and rocker arm 244 are accommodated within a housing of the actuator assembly, which includes a first or upper housing portion 248 and a second or lower housing portion 250 joined together. The rocker arm 244 may extend through an aperture in the first housing portion 248 to engage the cover panel 214 and move relative to the actuator assembly 228 when the motor 234 is electrically operated.

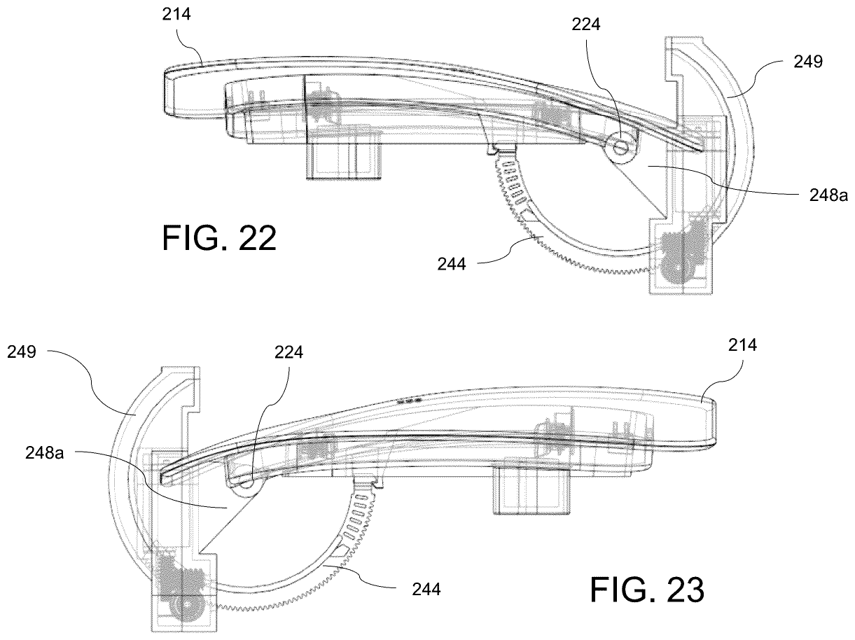

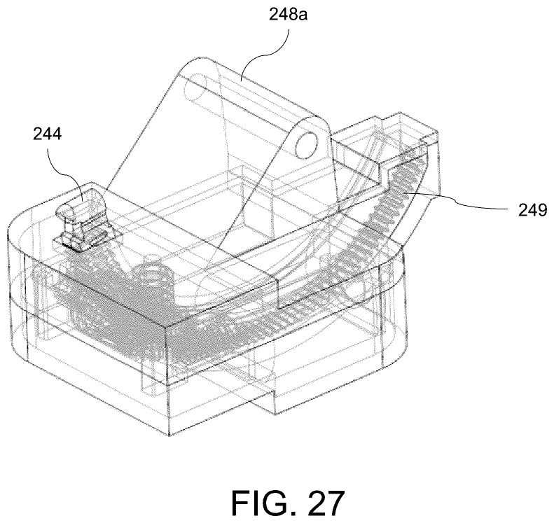

Referring to FIGS. 22, 23, and 26-33, when the cover panel 214 is in the closed position (FIG. 27), the arcuate gear element 244 is at least partially received along an arcuate channel 249 of the actuator housing, where the channel 249 may be formed as part of the upper housing portion 248 and/or the lower housing portion 250. When the cover panel 214 is in the opened position (FIGS. 22, 23, and 26), the arcuate gear element 244 moves with the cover panel 214 about the pivot axis and is thus moved out of the channel 249 and extended from the housing. Thus, when the motor 234 is operated to move the cover panel 214, the clutch assembly 242 travels along the arcuate gear element 244 to move the arcuate gear element 244 along the channel 249 and thus pivot the cover panel 214 relative to the base portion 213 about the pivot pin 224. The channel 249 and the arcuate gear element 244 may at least partially circumscribe the pivot pin 224 and the arcuate gear element 244 couples to the cover panel 214 at a radial distance from the pivot pin 224.

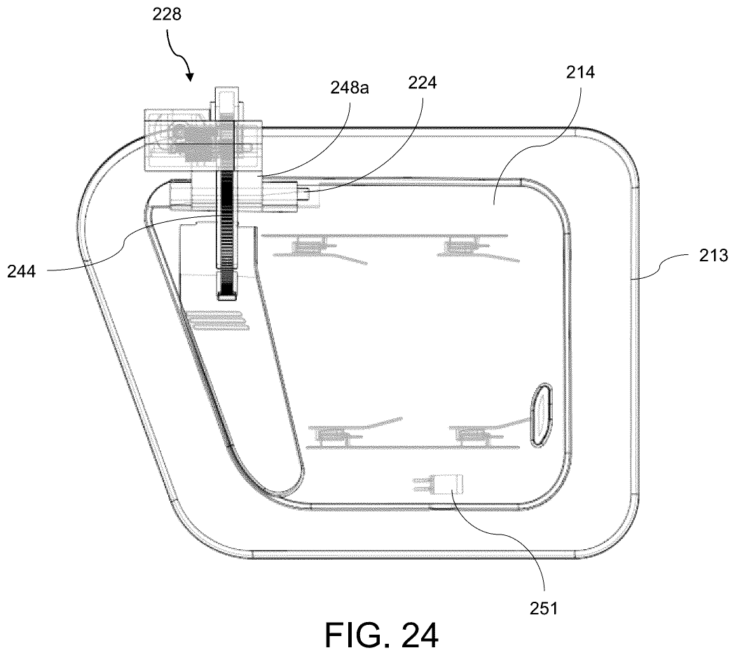

Optionally, and such as shown in FIGS. 24 and 25, one or more sensors 251 (such as a radar sensor or a radio frequency identification (RFID) sensor) may be disposed at the cover panel 214 (e.g., behind an outer surface of the cover panel) for detecting presence of a key fob and/or a user's hand at or near the cover panel for actuating the actuator 228 for opening and closing the cover panel 214. Optionally, the sensor is configured to detect proximity to objects at or near the cover panel 214 to control opening of the cover panel 214 based on proximity of the cover panel 214 to a detected object. For example, the actuator 228 may open the cover panel toward an object and only to a degree such that the cover panel 214 does not contact the detected object.

Thus, the charge port 212 provides a power charge flap that utilizes a hinge pin 224. The charge port 212 provides an alternative option for power charge flaps that utilizes a pivot axis and a gear train to open and close the power charge flap 214. The system transmits enough power or force at the cover panel (e.g., 100 Newtons or more, 150 Newtons or more, 250 Newtons or more, and the like) to break through ice build-up at the exterior of the flap. A body panel may be assembled over the charge flap 214, or integrated with the charge flap 214 to provide a substantially smooth or continuous outer surface of the vehicle.

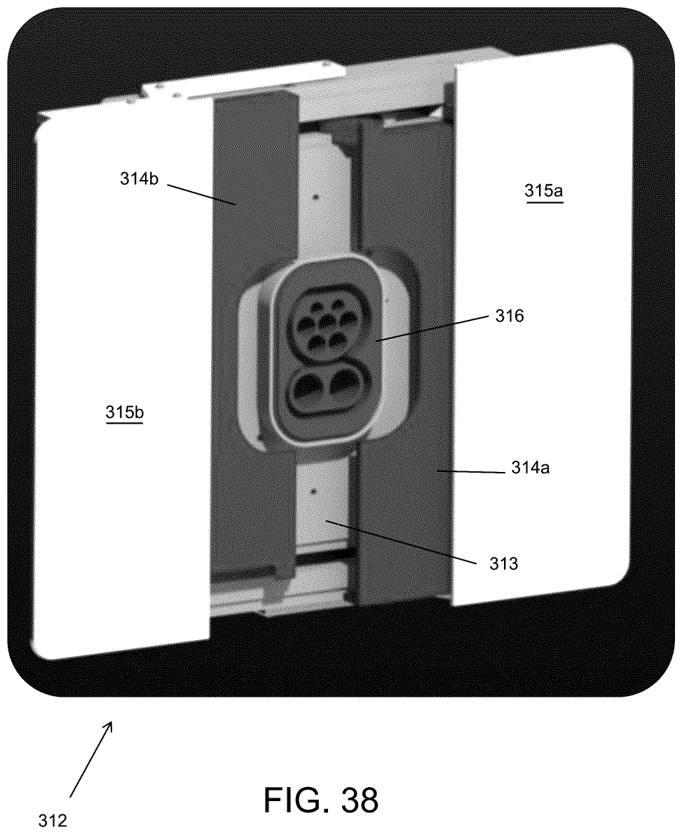

Optionally, the charge port may include one or more cover panels that slidably move at least partially sideward along the side of the vehicle when moved between the closed position and the opened position. For example, and referring to FIGS. 38-43, a charge port 312 includes a base portion or mounting bracket 313 configured for mounting at the vehicle and one or more cover panels or flaps or wings 314 that are slidably mounted at the base portion 313. When the one or more cover panels 314 are in the closed position, the cover panels 314 are substantially flush with an outer surface of the vehicle at and around the charge port and the cover panels 314 conceal and protect the charging connector 316 of the charge port 312. When the one or more cover panels 314 are moved from the closed position toward the opened position, the one or more cover panels 314 move laterally relative to the base portion 313 and along the outer surface of the vehicle to provide access to charging connector 316. The charge port 312 may include cover panels that move laterally relative to the base portion 313 in opposing directions away from one another (e.g., left and right in FIG. 38) to separate from one another and provide access to the charging connector 316.

For example, the one or more cover panels 314 may include a first inner wing 314a and a second inner wing 314b that, in the closed position, are disposed over the charging connector 316 and may be disposed adjacent one another such that adjacent edge portions of the inner wings engage and may seal to one another over the charging connector 316. Optionally, a portion of the respective edge portions of the first inner wing 314a and the second inner wing 314b may engage a portion of the base portion 313 at or near or adjacent the charging connector 316. When moved to the opened position, the first inner wing 314a moves in a first direction (e.g., right in FIG. 38) relative to the base portion 313 and the second inner wing 314b moves in an opposite second direction (e.g., left in FIG. 38) to separate from one another. The cover panel 314 may also include a first outer wing 315a and a second outer wing 315b that, in the closed position, are disposed over the charging connector 316 and the inner wings and may be disposed adjacent one another such that adjacent edge portions of the outer wings engage and may seal to one another over the inner wings. When moved to the opened position, the first outer wing 315a moves in the first direction (e.g., right in FIG. 38) relative to the base portion 313 and the second outer wing 315b moves in the second direction (e.g., left in FIG. 38) to separate from one another. Thus, with the inner and outer wings in the opened positions, the charging connector 316 is accessible for connection to the charging wand.

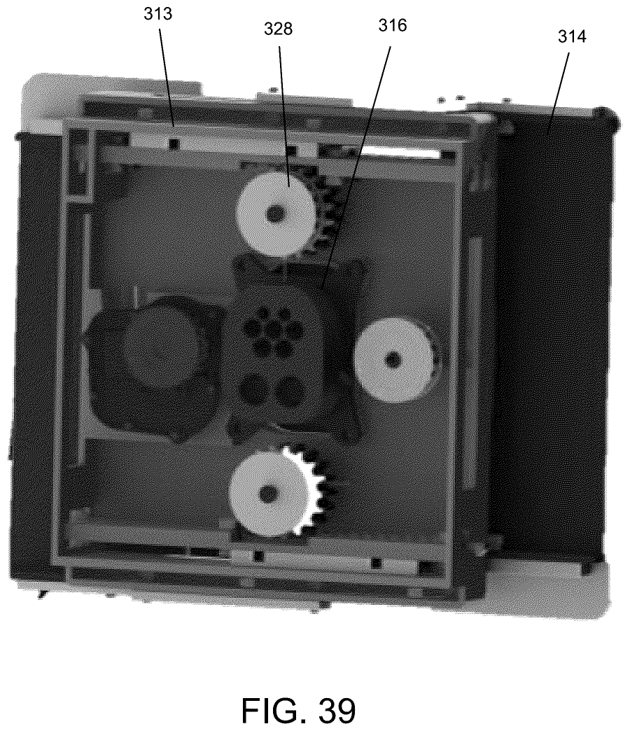

As shown in FIGS. 39-43, an actuator assembly 238 may be disposed at the base portion 213 (such as at a rear surface or inner portion of the base portion and surrounding the charging connector 316) and electrically operable to move the cover panel 314 between the opened position and the closed position relative to the base portion 313. The first inner wing 314a, second inner wing 314b, first outer wing 315a, and second outer wing 315b are each slidably or movably mounted at the base portion 313 such that the respective wings are independently movable relative to the base portion 313. For example, respective fasteners 352, such as screws or shoulder bolts or other suitable fasteners, may couple the respective wings to the base portion 313 and be received in and movable along respective slots formed through the base portion 313. Optionally, the first inner wing 314a and the second inner wing 314b are moved simultaneously and in opposite directions to one another, and the first outer wing 315a and the second outer wing 315b are moved simultaneously and in opposite directions to one another.

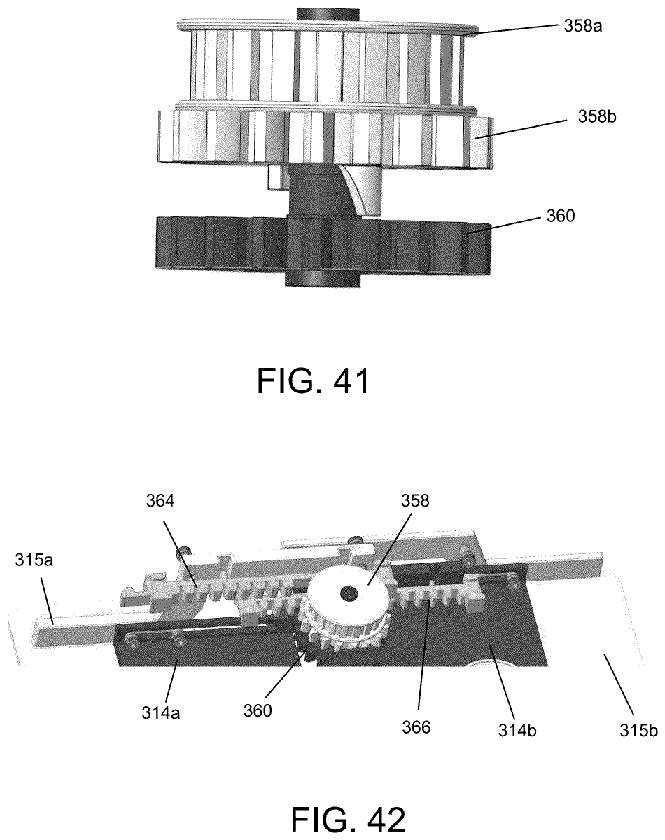

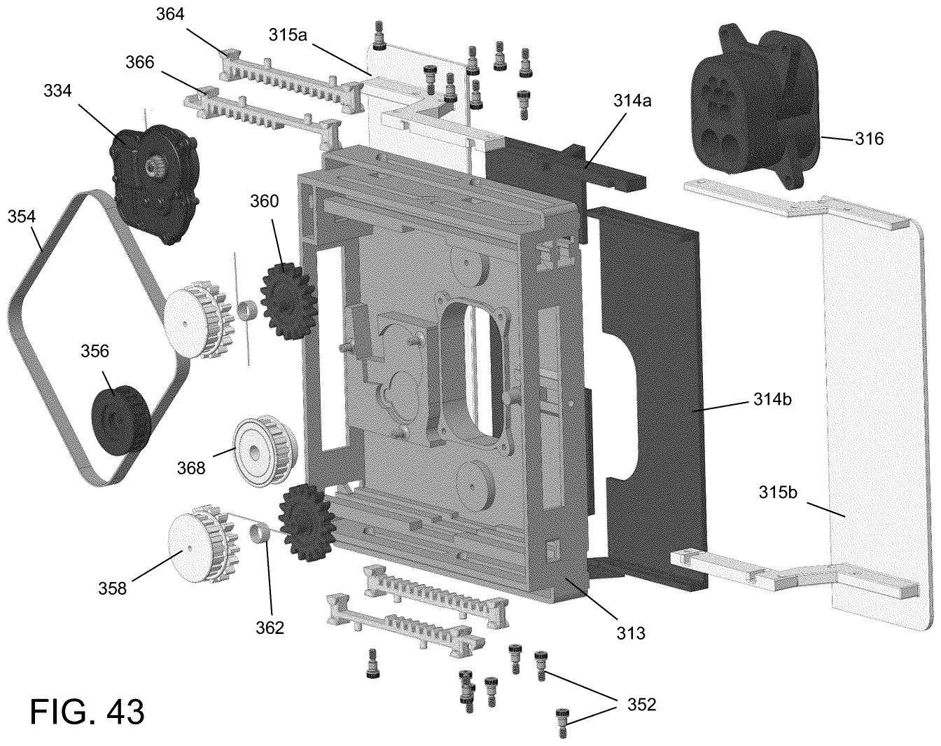

An electrically operable motor 334 is mounted at the base portion 313 and electrically operable to move the cover panel 314 by rotatably driving a gear train coupled to the motor 334 via a drive gear 356 and a drive belt 354. When the motor 334 drives the drive gear 356, the drive gear 356 in turn drives the belt 354 and the belt 354 drives a first portion 358a of a permanent gear 358. The permanent gear 358 includes a second portion 358b mechanically coupled to the first outer wing 315a and the second outer wing 315b for moving the outer wings between the opened position and the closed position when the permanent gear 358 is rotatably driven. As shown in FIG. 41, a friction gear 360 is coupled to the permanent gear 358 and rotatable relative to the permanent gear 358 according to a frictional engagement between the friction gear 360 and the permanent gear 358. For example, a biasing element such as a torsion spring 362 may be disposed between the friction gear 360 and the permanent gear 358 to bias the friction gear 360 into engagement with the permanent gear 358 (FIG. 43). The friction gear 360 is mechanically coupled to the first inner wing 314a and the second inner wing 314b so that, when the friction gear 360 is rotatably driven by the permanent gear 360, the inner wings move between the opened position and the closed position.

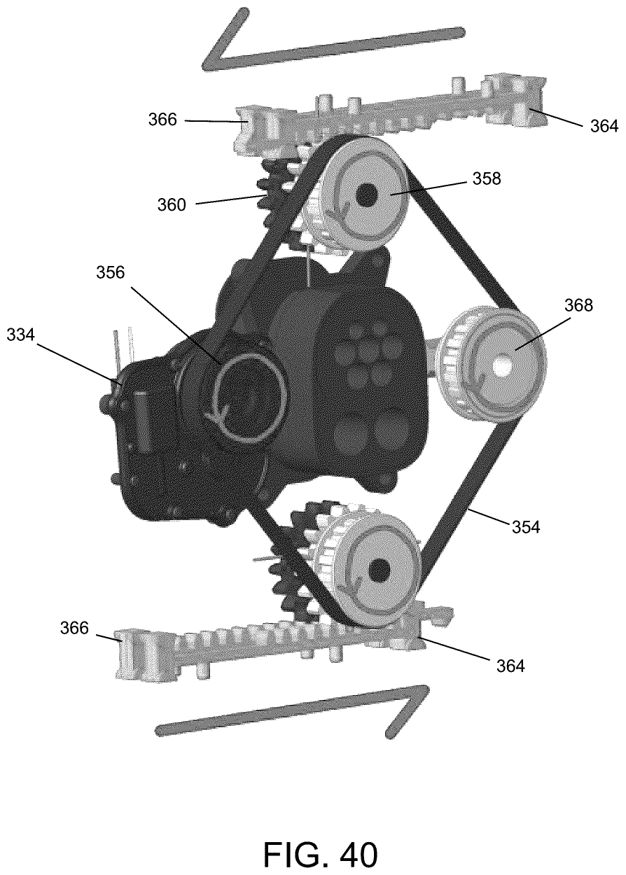

As shown in FIGS. 40, 42 and 43, the permanent gear 358 is mechanically coupled to the outer wings via an outer rack 364 that is driven by the second portion 358b of the permanent gear and moves laterally along the base portion 313 according to movement of the outer wings. The friction gear 360 is mechanically coupled to the inner wings via an inner rack 366 that is driven by the friction gear 360 and moves laterally along the base portion 313 according to movement of the inner wings. As shown in FIG. 40, the actuator assembly 328 may include upper and lower portions so that, when the motor 334 is electrically operated and moves the drive belt 354 in a first pivotal direction (e.g., counterclockwise in FIG. 40), the upper and lower permanent gears and upper and lower friction gears move in the same direction, and the upper outer and inner racks move in a first lateral direction (e.g., left in FIG. 40) and the lower outer and inner racks move in an opposite second lateral direction (e.g., right in FIG. 40). Thus, the upper racks may be respectively coupled to the first inner wing and the first outer wing and the lower racks may be respectively coupled to the second inner wing and the second outer wing. A tension gear 368 may be disposed between the upper and lower gear trains and on an opposite side of the motor 334.

Thus, the charge port 312 provides a power charge flap with increased environmental protection and eye-catching kinematics. A dual-door system allows for a cover while charging and a decreased profile from the side of the vehicle when the cover panel is open. The charge port decreases the exposed inner area, such as to only the size of the charge gun, with inward sliding. A friction gear train allows for independent wing motion and the belt system allows for the gear train to be configured and installed around any suitable charge port.

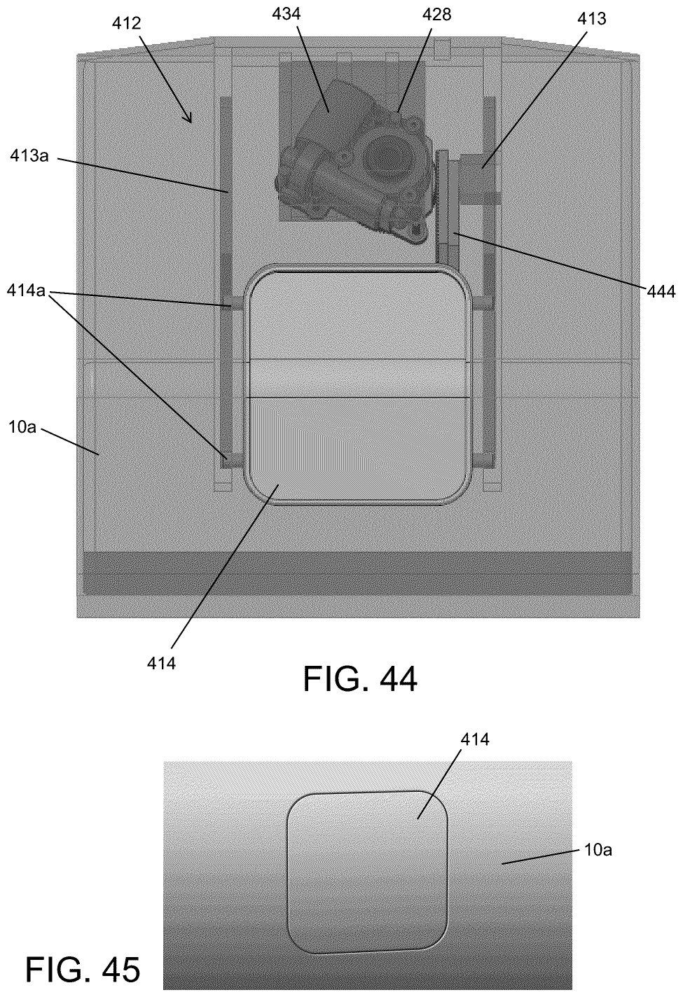

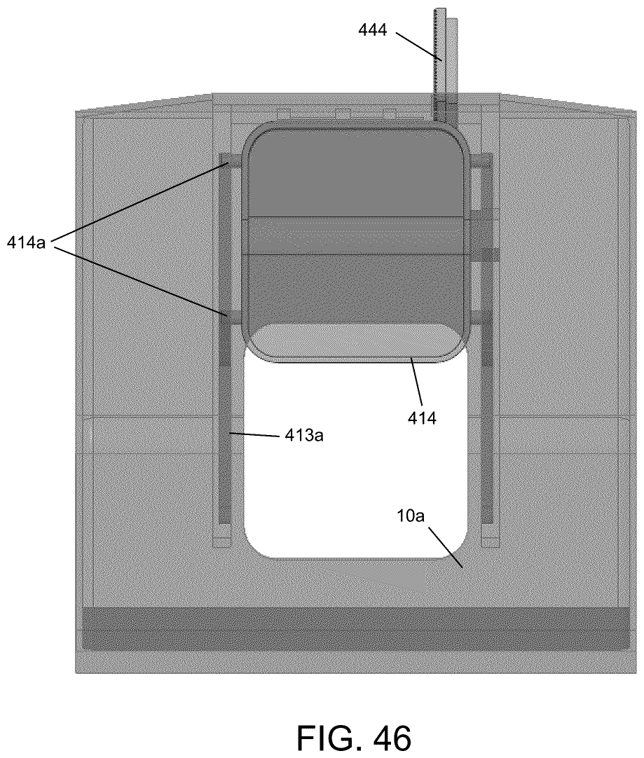

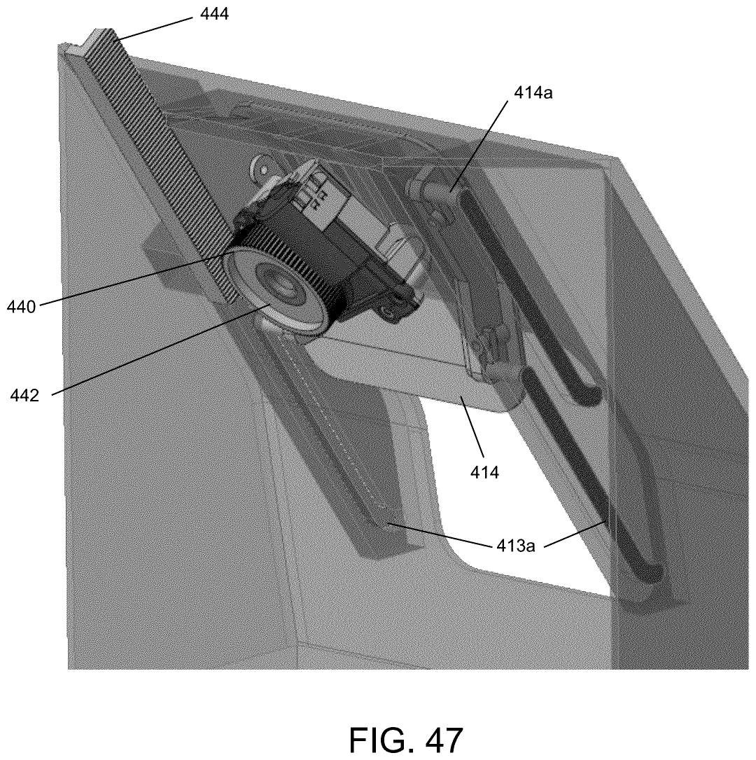

Optionally, the charge port may operate to move the cover panel at least partially inward toward the side of the vehicle and along an inner portion of the body panel of the vehicle when moved from the closed position toward the opened position. For example, and referring to FIGS. 44-47, a charge port 412 includes a cover panel 414 that is substantially flush with and corresponds to the exterior surface of the vehicle body panel 10a when in the closed position (FIGS. 44 and 45) and that slides inward from the exterior surface of the vehicle and along an inner portion of the vehicle body panel 10a when moved from the closed position toward the opened position (FIGS. 46 and 47). A base portion or mounting bracket 413 mounts at the inner surface of the vehicle body panel 10a and includes guide channels or rails or slots 413a that extend inward from the vehicle body panel 10a and away from the aperture in the body panel 10a at which the charging connector is positioned. Optionally, the slots 413a may be formed along respective sidewalls extending inward and formed with the body panel 10a. Respective pins or pegs 414a extend from the cover panel 414 and are received in the guide rails 413a so that, when the cover panel 414 is moved between the closed position and the opened position, the pins 414a travel along and ride inside of the respective guide rails 413a to guide movement of the cover panel 414 inward and away from the aperture in the body panel 10a.

The guide rails 413a may define any suitable path of travel for the cover panel 414. For example, the guide rails 413a may be substantially S-shaped or L-shaped to guide the cover panel 414, from the closed position, inward from the body panel 10a and upward along the inner portion of the body panel 10a to provide access to the charging connector. When the cover panel 414 is in the closed position, the cover panel 414 may seal the aperture in the body panel 10a, such as via a rubber seal or gasket disposed about the outer edge region or perimeter of the cover panel 414. Thus, the guide rails 413a may be configured to guide the cover panel 414 into a cinching or sealing position at the closed position.

An actuator assembly 428 is coupled to the base portion 413 and drives a rack and pinion mechanism for moving the cover panel 414 into and up along the body panel 10a from the closed position toward the opened position. For example, an electrically operable motor 434 is electrically operable to drive a gear train coupled to a driving gear 440. The driving gear 440 engages a linear gear or rack 444 coupled to the cover panel 414 and, when the driving gear 440 drives the rack 444, the rack 444 travels along the driving gear 440 and the cover panel 414 moves along the guide rails 413a. The driving gear 440 is coupled to the gear train of the actuator assembly 428 via a clutch plate 442 to allow the driving gear 440 to slip relative to the gear train and motor 434, such as when the cover panel 414 is manually moved between the closed position and the opened position or when resistance prevents the cover panel 414 from moving along the guide channels 413a (e.g., the motor 434 is operated to close the cover panel when the charging wand is still connected to the charging connector). The clutch plate 442 may be utilized instead of a detent plate.

Thus, the charge flap includes a rack and pinion mechanism for lifting the power charge flap into and up along the body panel. The compact powerfold actuator that is operable to move the panel between the closed position and the opened position includes a clutch plate and driving gear instead of a detent plate. Pegs located on the moving flap ride inside of slots located on the body panel or mounting bracket. The power charge flap slides in or behind the body panel of the vehicle rather than deploying outward. The system utilizes a rack and pinion mechanism for moving the power charge flap up, into, and behind the vehicle body panel. The charge port is compact, has few moving parts, and seals out environmental debris and moisture. The system includes brackets and housings that form a self-contained unit that can be fastened to the vehicle as a singular unit.

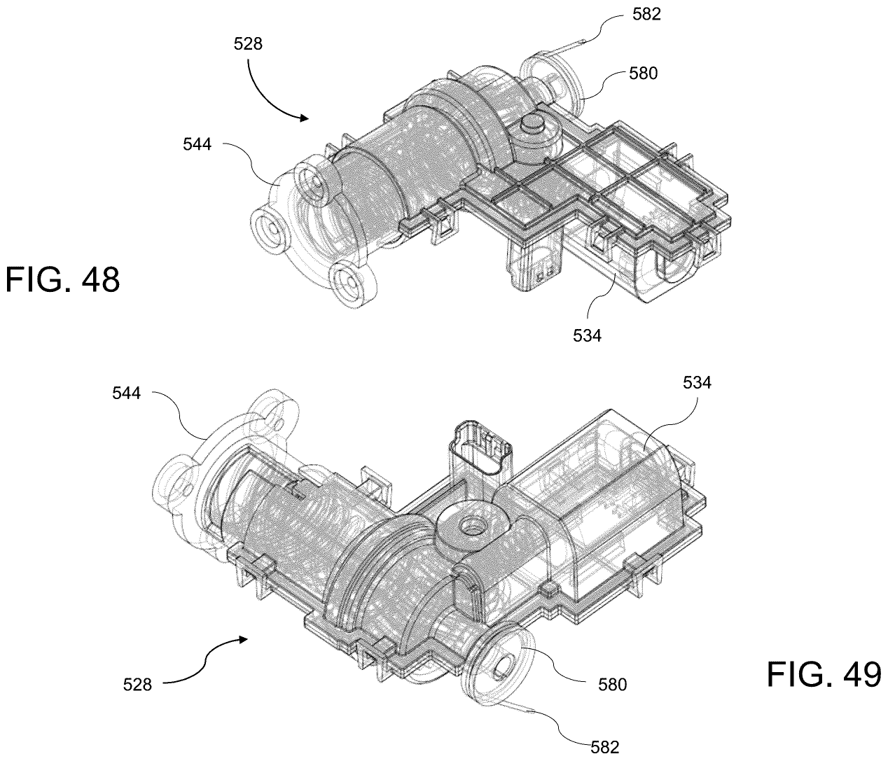

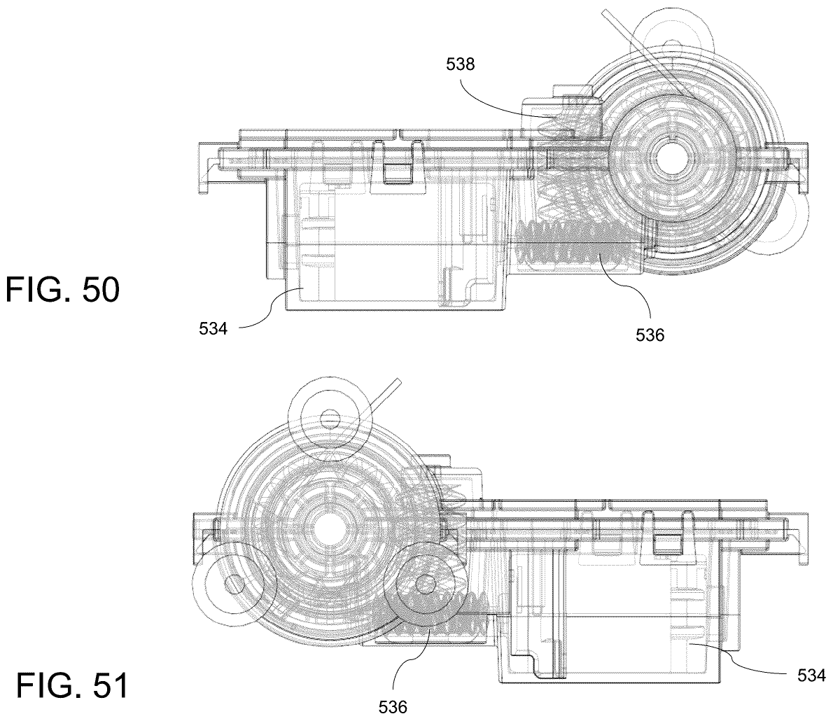

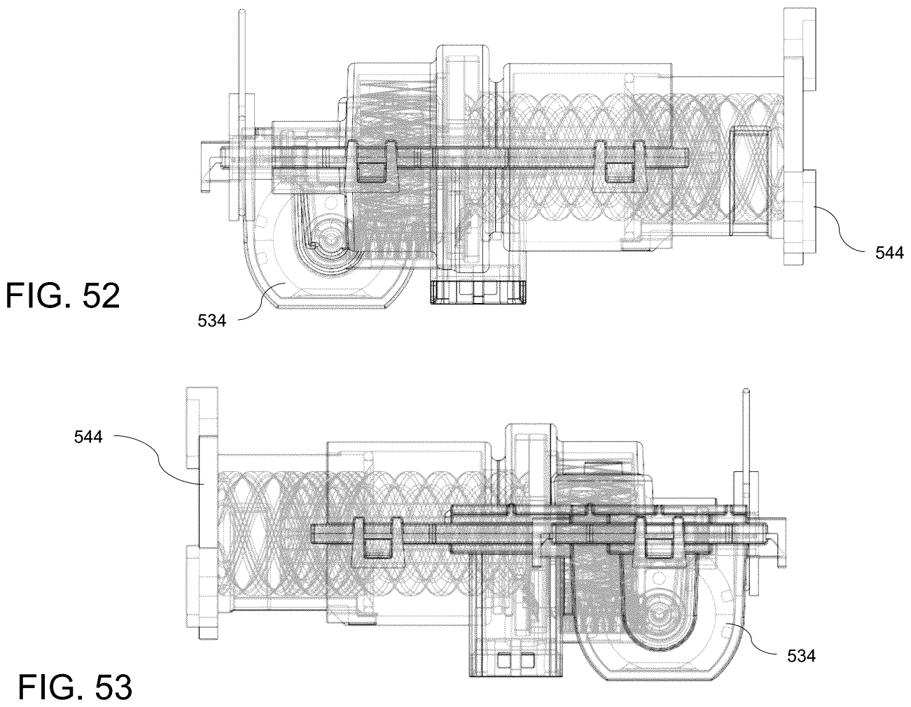

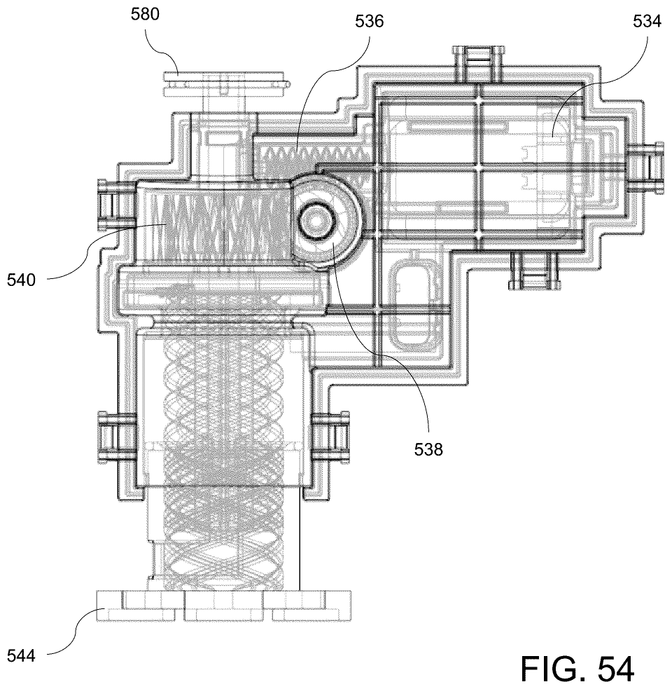

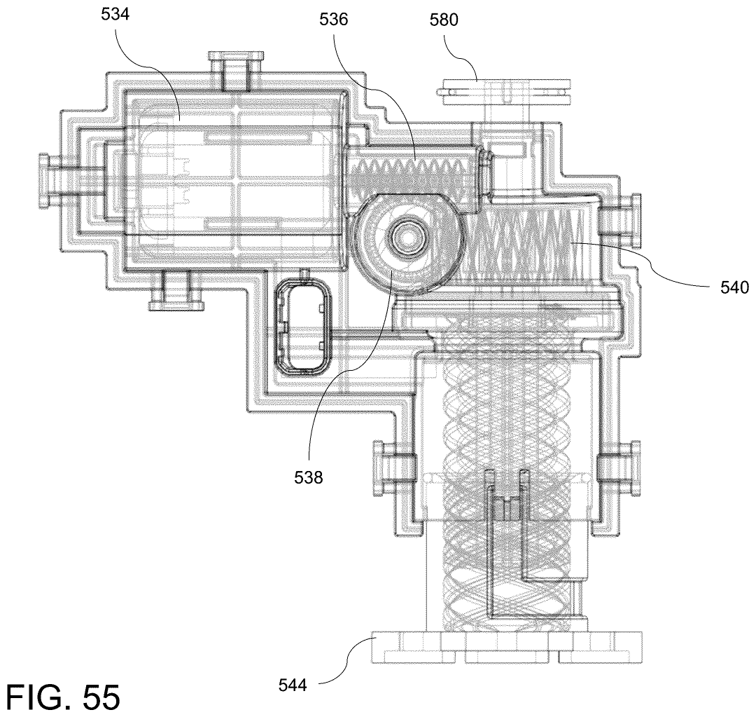

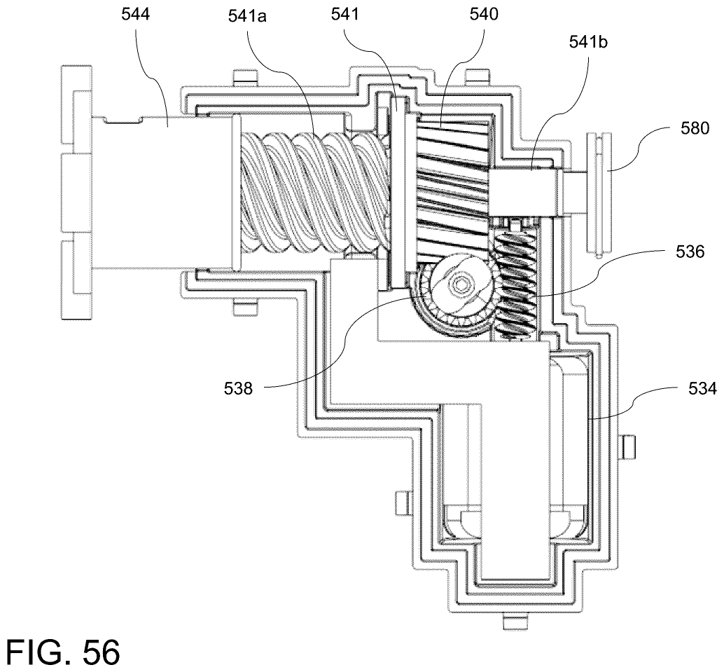

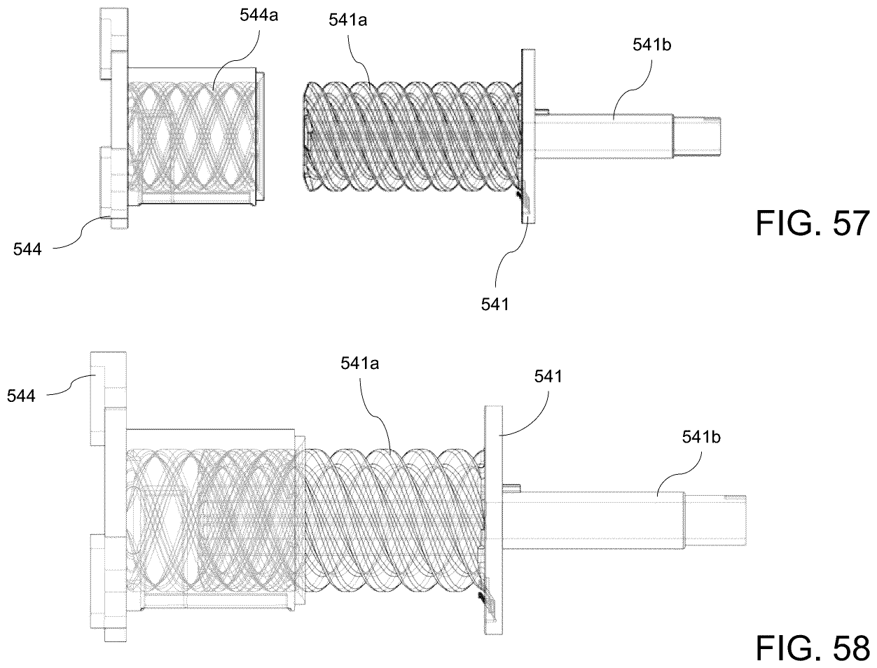

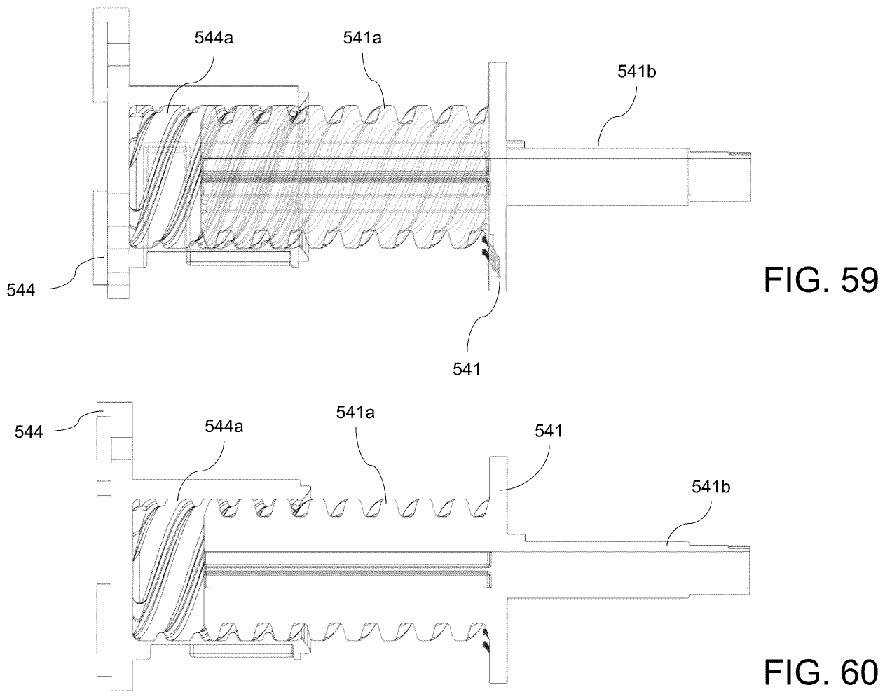

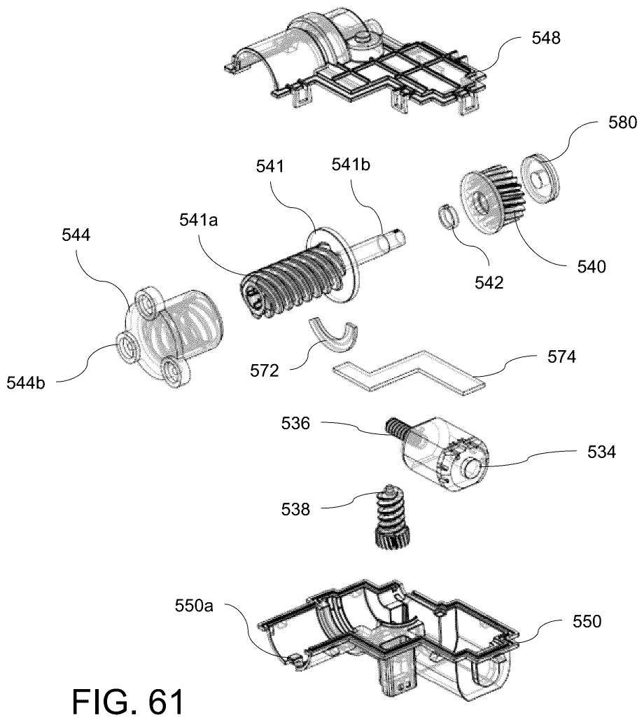

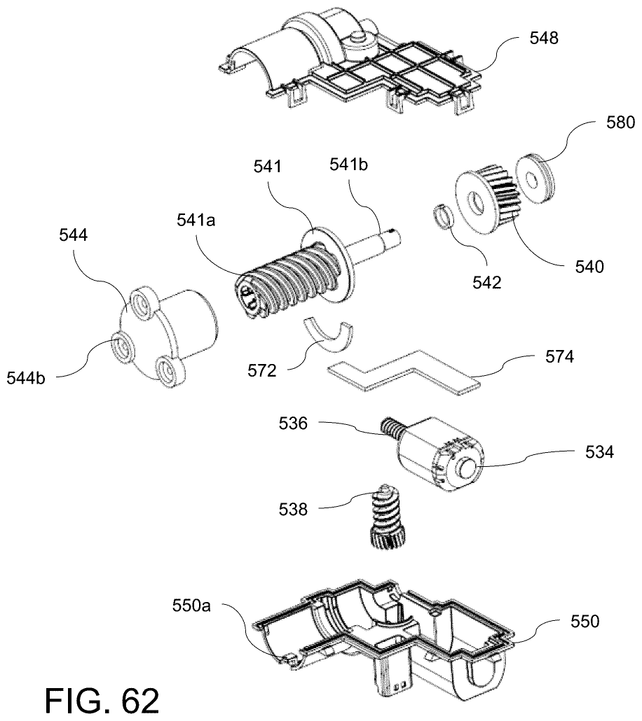

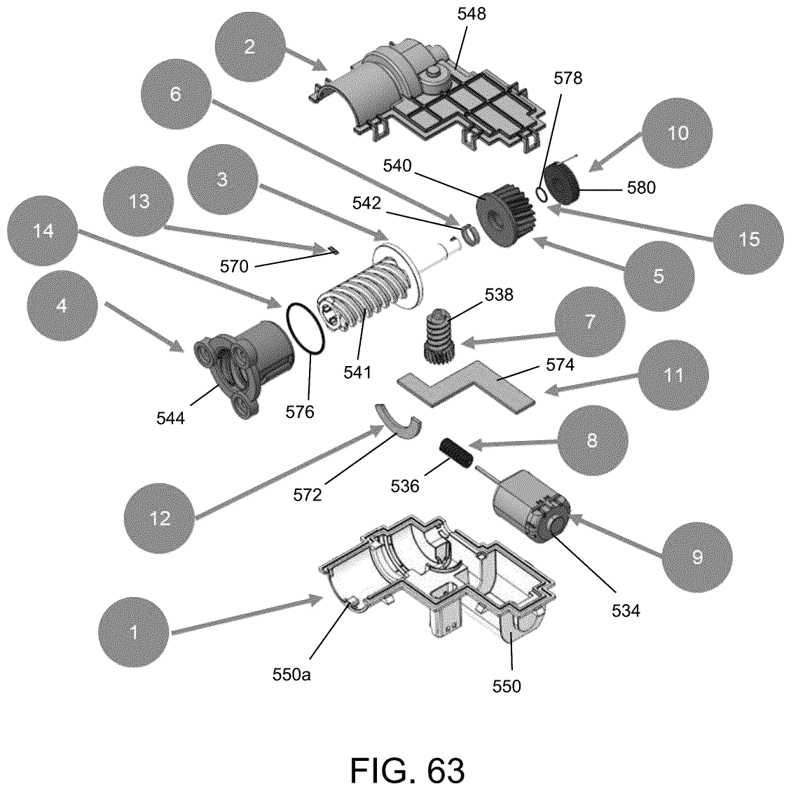

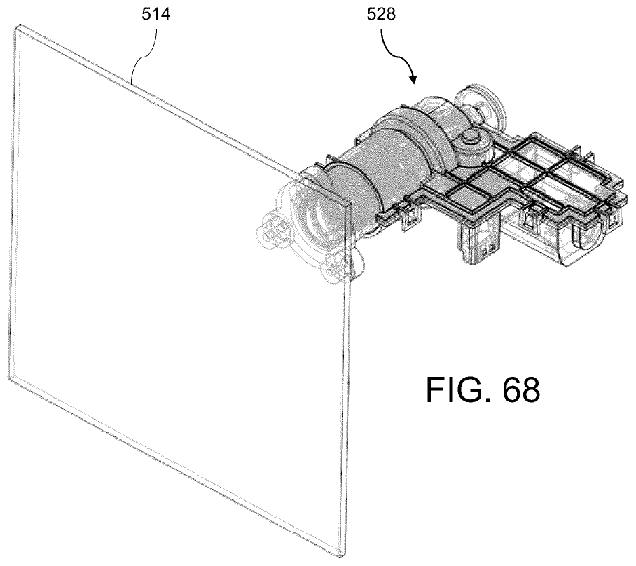

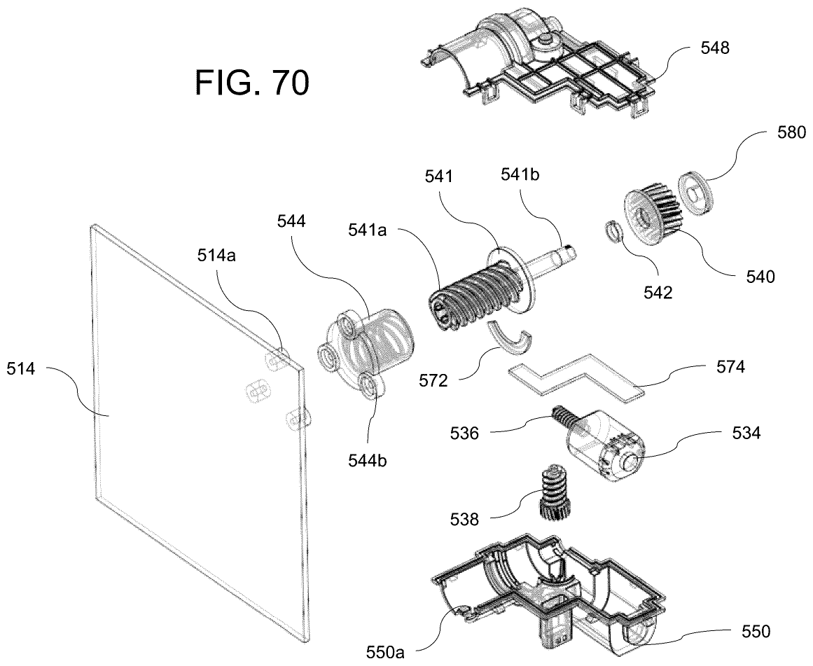

In some examples, the charge port system operates to pivot the cover panel relative to the side of the vehicle between the closed position and the opened position. For example, and referring to FIGS. 48-73D, a charge port 512 includes a cover panel 514 that is pivotably mounted relative to the body panel 10a of the vehicle and that moves between a closed position, where the cover panel 514 covers an aperture in the body panel 10a at which the charging connector is disposed and an outer surface of the cover panel 514 is substantially flush with an outer surface of the body panel 10a at the charge port 512, and an opened position, where the cover panel 514 is pivoted away from the aperture in the body panel 10a to provide access to the charging connector. As discussed further below, the cover panel 514 pivots relative to the body panel 10a about a pivot axis that is substantially perpendicular to a plane of the cover panel 514 and a plane of the body panel 10a. When moved from the closed position toward the opened position, the cover panel 514 moves linearly or axially along the pivot axis and then pivots about the pivot axis. Thus, when moved from the closed position toward the opened position, the cover panel 514 first moves inward or outward from the body panel 10a and then pivots along either the inner surface or the outer surface of the body panel 10a.

Referring to FIGS. 48-67, the actuator assembly 528 includes an electrically operable motor 534 that, when electrically operated to move the cover panel 514 between the opened position and the closed position, rotatably drives a worm gear 536 coupled to the motor 534. The worm gear 536 rotatably drives a first gear or main gear or combo gear 538 of a gear train of the actuator assembly 528 which in turn drives a second gear or helical gear 540 of the gear train. The second gear 540 is coupled to a lead screw or threaded element 541 with a clutch pad or element or spring 542 disposed between the second gear 540 and the lead screw 541 to allow the lead screw 541 and gear train to slip relative to one another. The helical gear 540 is disposed along a shaft portion 541b of the lead screw 541 and a threaded portion 541a at an opposite end of the lead screw 541 is received along a corresponding threaded portion 544a of a lead nut or receiver element 544 so that the lead nut 544 may move along a longitudinal axis of the lead screw and/or pivot about the longitudinal axis of the lead screw 541. With the lead nut 544 coupled to the inner surface of the cover panel 514, the longitudinal axis of the lead screw 541 defines a pivot axis of the charge port 512.

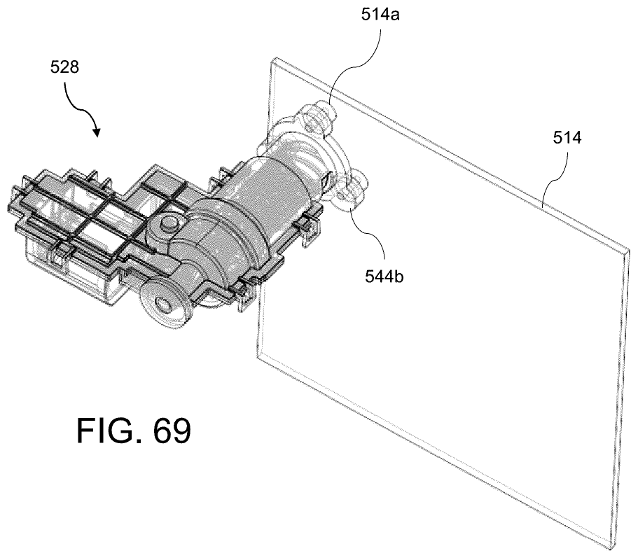

The motor 534, gear train, lead screw 541 and at least a portion of the lead nut 544 are accommodated within a housing of the actuator assembly 528, including a first or upper housing portion 548 and a second or lower housing portion 550 joined together. The lead nut 544 extends from the actuator housing and is attached to the inner surface of the cover panel 514. For example, the lead nut 544 may include one or more feet or receiving portions 544b that engage and at least partially receive corresponding protrusions 514a at the rear surface of the cover panel 514 (FIG. 69). The protrusions 514a may be fixed to the receiving portions 544b in any suitable manner, such as via adhesive or threaded fasteners.

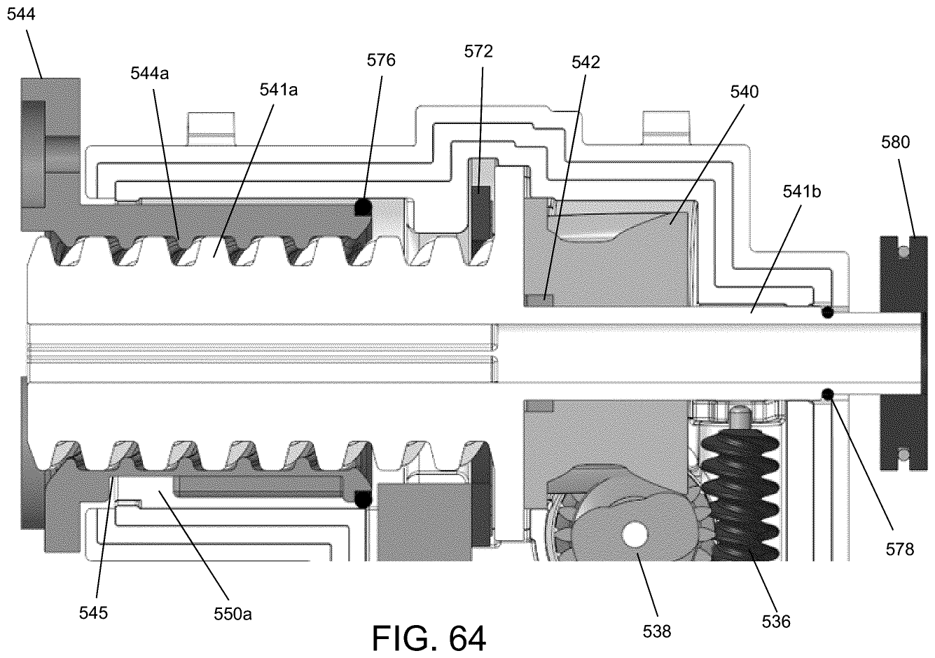

Referring to FIGS. 64-73D, when the charge port 512 is disposed at the vehicle, the actuator housing may be fixedly mounted at a base portion or mounting bracket of the charge port and fixed relative to the base portion and the cover panel 514. The lead screw 541 is axially fixed relative to the actuator housing and the lead nut 544 moves relative to the actuator housing along the longitudinal axis of the lead screw and/or about the longitudinal axis of the lead screw according to rotation of the lead screw 541. A guide rib 550a extends from an inner surface of the housing (e.g., an inner surface of the lower housing portion 550) and is received along a channel or guide 545 formed along an outer surface of the lead nut 544 to guide pivotable and/or linear movement of the lead nut 544 relative to the lead screw 541 and actuator assembly.

The channel 545 formed along the lead nut 544 includes a first portion 545a formed along the longitudinal axis of the lead nut 544 (parallel to the longitudinal axis of the lead screw and the pivot axis of the charge port) and a second portion 545b that extends from the first portion 545a substantially perpendicular to the first portion 545a and formed circumferentially along the lead nut 544. Thus, when the guide rib 550a is disposed in the linear first portion 545a of the channel 545 and the lead screw 541 drives the lead nut 544, the guide rib 550a constrains rotation of the lead nut 544 and the lead nut 544 and cover panel 514 move along the longitudinal axis of the lead screw 541. When the guide rib 550a is disposed in the circumferential second portion 545b of the channel 545 and the lead screw 541 drives the lead nut 544, the guide rib 550a constrains linear movement of the lead nut 544 and the lead nut 544 and cover panel 514 pivot about the longitudinal axis of the lead screw 541.

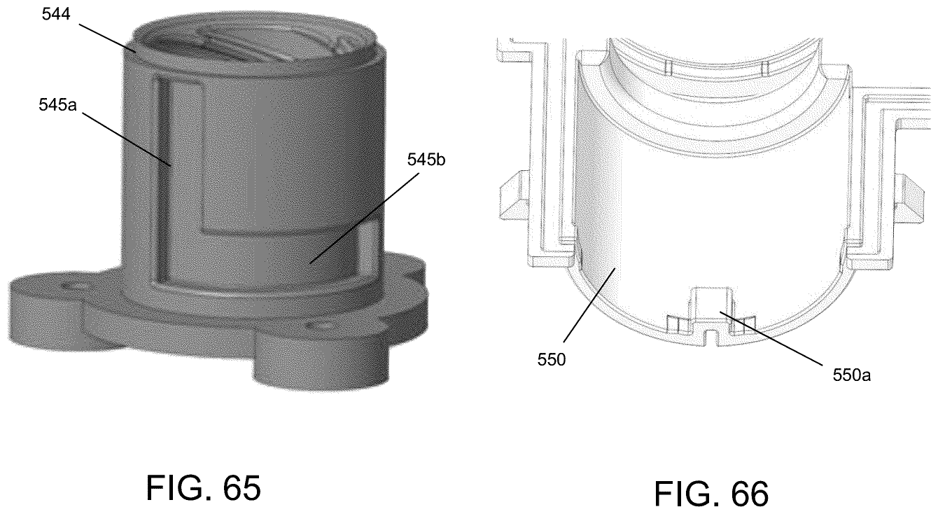

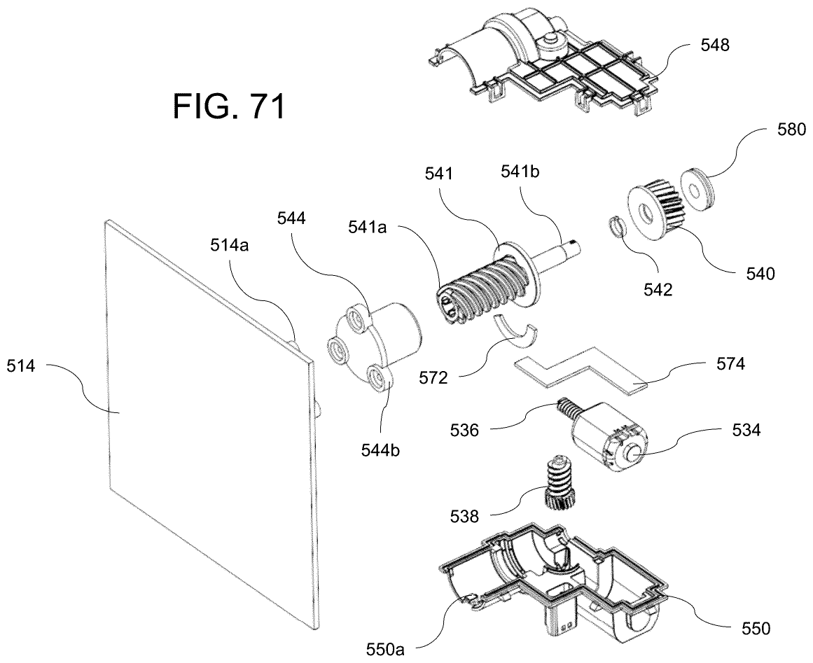

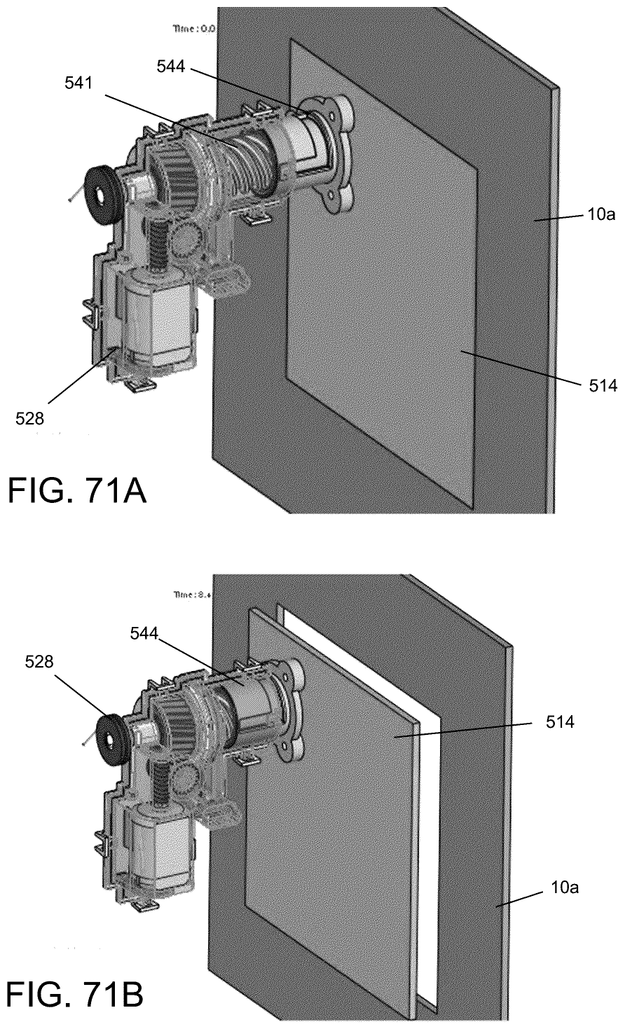

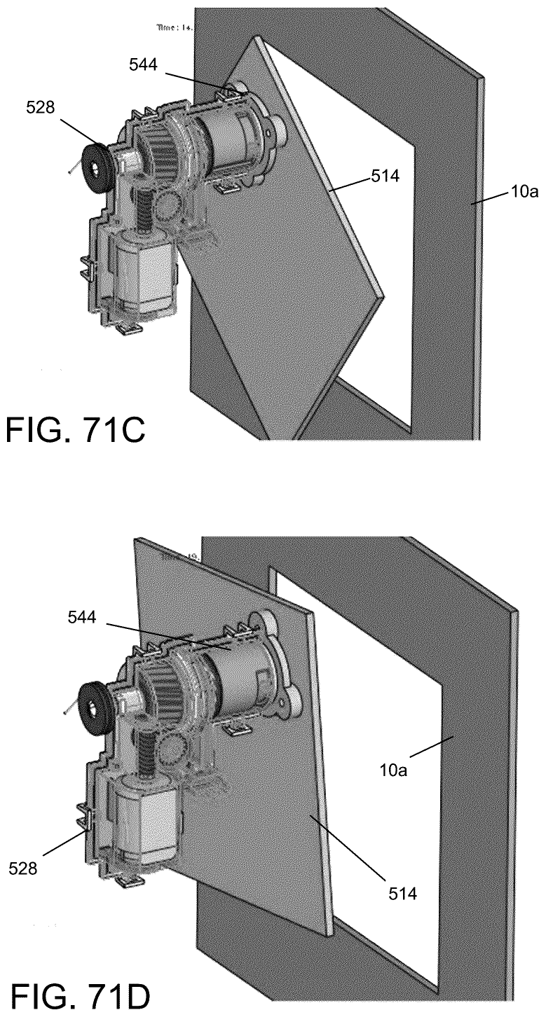

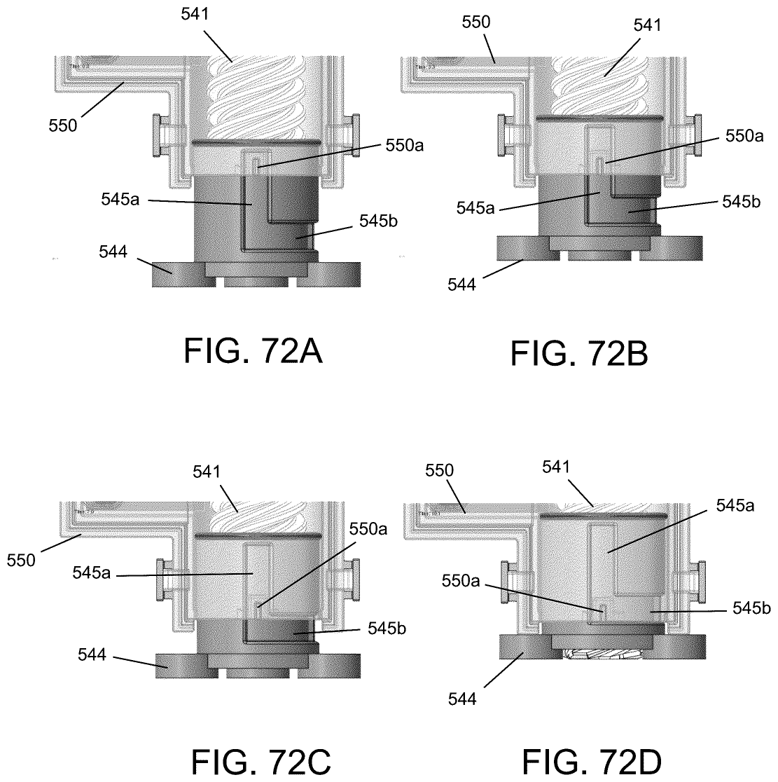

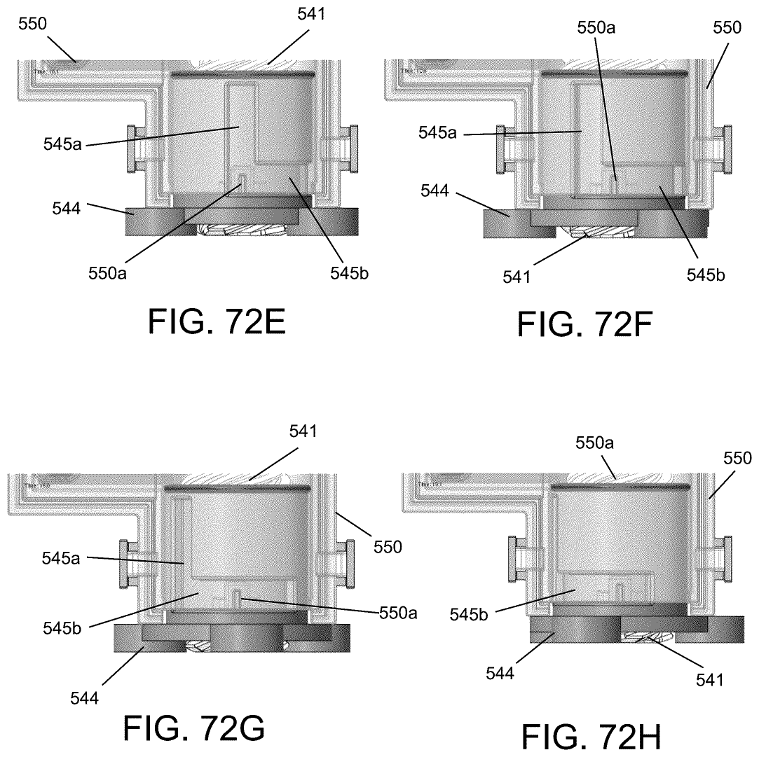

In the illustrated example of FIGS. 65, 71A-71D, and 72A-72H, the actuator assembly 528 includes the lead nut 544 where the linear first portion 545a of the channel 545 extends from an end of the lead nut proximal to the lead screw and the circumferential second portion 545b of the channel 545 extends from the first portion 545a at an opposite end of the lead nut proximal to the cover panel 514. Thus, when the cover panel 514 is in the closed position (FIGS. 71A and 72A) the lead nut 544 is extended from the actuator housing and the guide rib 550a is disposed in the linear first portion 545a of the channel 545 at the end of the lead nut 544 distal from the cover panel 514. When the motor 534 is operated and the helical gear 540 drives the lead screw 541 in a first direction, the guide rib 550a constrains rotation of the lead nut 544 and the lead nut 544 travels along the longitudinal axis of the lead screw 541 inward toward the actuator assembly and the guide rib 550a travels along the channel 545 toward the second portion 545b of the channel (FIGS. 71B and 72B-72D). Thus, the actuator assembly 528 with the lead nut 544 coupled to the cover panel 514 is configured to move the cover panel 514 inward toward the side of the vehicle before pivoting the cover panel 514.

With the cover panel 514 moved inward along the longitudinal axis of the lead screw 541 (FIG. 71B) and the guide rib 550a positioned at the end of the linear first portion 545a of the channel 545 proximal to the cover panel 514 (FIG. 72E), the lead screw 541 is driven further in the first direction to pivot the cover panel 514 relative to the actuator assembly 528. The cover panel 514 pivots about the longitudinal axis of the lead screw 541 and away from the aperture in the body panel 10a as the guide rib 550a moves along the circumferential second portion 545b of the channel 545 (FIGS. 71C, 71D, and 72F-72H). When the guide rib 550a reaches the end of the second portion 545b of the channel 545 opposite the first portion 545a, the actuator reaches a travel stop and the cover panel 514 is in the opened position. To close the cover panel 514, the lead screw 541 is driven in an opposite second direction and the cover panel 514 pivots back in front of the aperture and then is moved outward from the actuator assembly 528 toward the body panel 10a of the vehicle.

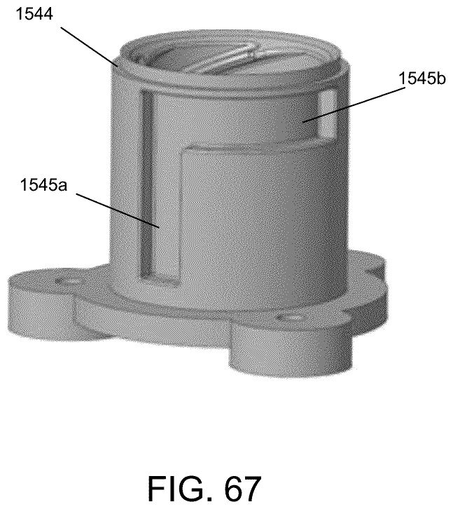

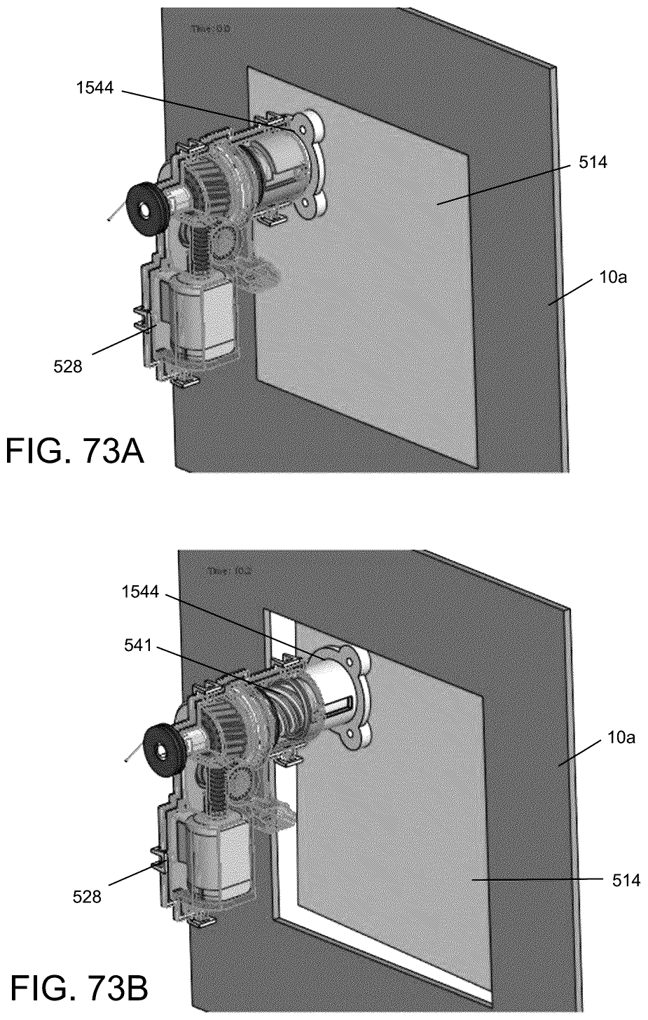

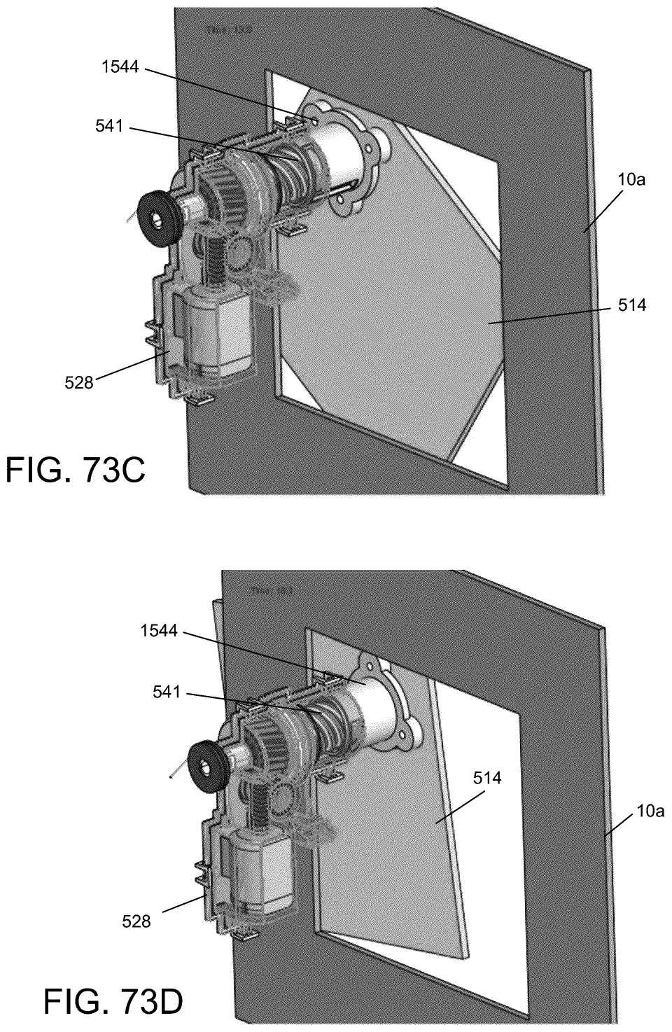

Optionally, and such as shown in FIGS. 67 and 73A-73D, the actuator assembly 528 may be equipped with a lead nut 1544 where the circumferential second portion 1545b of the channel 1545 is disposed at the end of the lead nut 1544 proximal to the actuator assembly (i.e., distal from the cover panel 514) and the linear first portion 1545a of the channel 1545 extends from the second portion 1545b and along the longitudinal axis of the lead nut 1544 toward the end of the lead nut 1544 coupled to the cover panel 514.

Thus, when the cover panel 514 is in the closed position (FIG. 73A) the lead nut 1544 is recessed toward and/or into from the actuator housing and the guide rib 550a is disposed in the linear first portion 1545a of the channel 545 at the end of the lead nut 1544 proximal to the cover panel 514. When the motor 534 is operated and the helical gear 540 drives the lead screw 541 in a first direction, the guide rib 550a constrains rotation of the lead nut 1544 and the lead nut 1544 travels along the longitudinal axis of the lead screw 541 outward away from the actuator assembly 528 and the guide rib 550a travels along the channel 1545 toward the second portion 1545b of the channel (FIG. 73B). Thus, the actuator assembly 528 with the lead nut 1544 coupled to the cover panel 514 is configured to move the cover panel 514 outward away from the side of the vehicle before pivoting the cover panel 514.

With the cover panel 514 moved outward along the longitudinal axis of the lead screw 541 (FIG. 73B) and the guide rib 550a positioned at the end of the linear first portion 1545a of the channel 1545 distal from the cover panel 514, the lead screw 541 is driven further in the first direction to pivot the cover panel 514 relative to the actuator assembly 528. The cover panel 514 pivots about the longitudinal axis of the lead screw 541 along the outer surface of the vehicle and away from the aperture in the body panel 10a as the guide rib 550a moves along the circumferential second portion 1545b of the channel 1545 (FIGS. 73C and 73D). When the guide rib 550a reaches the end of the second portion 1545b of the channel 1545 opposite the first portion 1545a, the actuator reaches a travel stop and the cover panel 514 is in the opened position. To close the cover panel 514, the lead screw 541 is driven in an opposite second direction and the cover panel 514 pivots back in front of the aperture and then is moved inward toward the actuator assembly 528 and toward the body panel 10a of the vehicle.

The actuator assembly 528 may be configured to provide a memory function, such as to track a current position of the cover panel 514 relative to the side of the vehicle. For example, a memory wiper 570 may be disposed at the lead screw 541 and a memory printed circuit board (memory PCB) 572 may be disposed at the actuator housing and configured to engage the memory wiper 570 so that, as the lead screw 541 pivots relative to the housing, the memory wiper 570 moves along the memory PCB 572. The position of the cover panel 514 may be determined based on a position of the memory wiper 570 along an electric trace of the memory PCB 572. The memory PCB 572 may be electrically coupled to a motor control or motor printed circuit board (motor PCB) 574 that controls operation of the electrically operable motor 534. Thus, the motor 534 may be controlled based on the tracked position of the control panel 514.

Optionally, and such as shown in FIG. 64, a first O-ring or seal or gasket 576 is disposed about the lead nut 544 and between the lead nut 544 and actuator housing. For example, the first O-ring 576 may promote smooth travel of the lead nut 544 relative to the actuator housing. Similarly, a second O-ring or seal or gasket 578 may be disposed about the shaft portion 541b of the lead screw 541 and between the lead screw 541 and the actuator housing.

A reel 580 may be disposed at an end of the shaft portion 541b of the lead screw 541 opposite the threaded portion 541a (FIGS. 48 and 49). The reel 580 may be rotationally fixed relative to the lead screw 541 such that the reel 580 and the lead screw rotate together and in tandem with one another. Thus, the reel 580 may provide a manual operation function for the actuator 528 such that the reel 580 may be manually moved or rotated to impart rotation of the lead screw 541 to move the cover panel 514 between the closed position and the opened position. For example, a cable or pull cord 582 may be coupled to (and optionally wound around) the reel 580 so that, when the user (or a separate motor or actuator) pulls the cord 582, the reel 580 may rotate to move the cover panel 514. Optionally, a biasing element (such as a torsion spring) may be disposed at the reel 580 for biasing the cover panel toward the closed position or the opened position (such that, when the cover panel is manually opened, the biasing element may bias the reel to rewind the cord and move the cover panel toward the closed position).

Thus, the charge port 512 includes a power charge flap 514 that slides in and behind the body panel 10a rather than deploying outward. Optionally, the charge flap 514 slides out and in front of the body panel 10a instead of deploying inward. The actuator assembly 528 provides a lead screw driven power charge flap 514, where the charge flap door 514 is attached to the lead nut 544 and the lead nut is moved by a driven lead screw 514 that is electrically driven. The rib 550a on the housing portion 550 rides in the guide channel 545 on the lead nut 544. The geometry of this channel controls linear and rotational travel of the charge flap door 514. The linear portion 545a of the channel 545 provides linear travel control and the circumferential portion 545b of the channel 545 provides rotational travel control. Optionally, the geometry of the channel 545 may be flipped so that the opening direction of the power charge flap may be changed. Furthermore, the charge port 512 provides position monitoring, manual override, and no damage to the actuator if movement of the cover panel is obstructed.

Aspects of the charging ports and charging systems described herein may be suitable for a fuel filler port or opening configured to receive a nozzle that delivers fuel (e.g., gasoline) to a fuel tank of the vehicle via the fuel port for powering a drive system of the vehicle. For example, the power fold flap system may utilize characteristics of the charge ports and charging systems described in U.S. Publication No. US-2023-0191926, U.S. patent applications, and/or U.S. patent application Ser. No. 18/476,362, filed Sep. 28, 2023 (Attorney Docket DON10 P4918), and/or U.S. provisional application Ser. No. 63/488,240, filed Mar. 3, 2023, U.S. provisional application Ser. No. 63/493,327, filed Mar. 31, 2023, U.S. provisional application Ser. No. 63/493,409, filed Mar. 31, 2023, U.S. provisional application Ser. No. 63/495,315, filed Apr. 11, 2023, U.S. provisional application Ser. No. 63/495,619, filed Apr. 12, 2023, and/or U.S. provisional application Ser. No. 63/496,031, filed Apr. 14, 2023, which are all hereby incorporated herein by reference in their entireties.

The charge ports described herein may be illuminated via any suitable means, and may utilize aspects of the charge ports and systems described in U.S. Pat. No. 8,317,376, which is hereby incorporated herein by reference in its entirety. The vehicle may include various indicators to indicate the charge level of the vehicle, such as by utilizing aspects of the systems described in U.S. Pat. No. 10,746,575 and/or U.S. Publication No. US 2021/0129757, which are hereby incorporated herein by reference in their entireties.

Optionally, the system and cover may operate to provide autonomous charging and may open the cover panel and pivot or move the charging connector responsive to determination of presence of the charging wand, and may control movement of the charging wand to guide the wand into electrical connection with the charging connector when the panel is opened and the connector is pivoted or moved to its charging position. The system may provide a passive way of charging electric vehicles (or plug-in hybrid vehicles or PHEVs) assisted by ultra-wideband (UWB) time of flight distance measurements (which may be made via processing of data captured by one or more time of flight sensors and/or transmitters disposed at the vehicle charge port and/or sensing or communicating with the charging wand), such as by utilizing aspects of the systems described in U.S. Publication No. US-2023-0133911, which is hereby incorporated herein by reference in its entirety. A communication gateway in communication with a PCF may automatically establish a connection with the charging station the electric vehicle is parked at. This automates the process of charging the vehicles (i.e., reduces or eliminates human intervention). The system allows for the charging station plug of the charging station to be guided to the charging socket of the electric vehicle using range and vector communication supplied by a UWB antenna system.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular charge port closure system, the vehicular charge port closure system comprising:
a cover panel disposed at a vehicle equipped with the vehicular charge port closure system, wherein the cover panel is movable between (i) a closed position, where the cover panel conceals a charge port of the vehicle, and (ii) an opened position, where the cover panel is moved away from the charge port to allow access to a charging connector of the charge port;
an actuator that is electrically operable to move the cover panel between the closed position and the opened position;
wherein the actuator comprises (i) an electrically operable motor operable to drive an input gear of a gear train, (ii) an output element coupled to the cover panel and (iii) a clutch element coupled to the output element and to an output gear of the gear train;
wherein the output element, as the cover panel moves between the closed position and the opened position, moves together and in tandem with the cover panel;
wherein the electrically operable motor, when the actuator is electrically operated to move the cover panel between the closed position and the opened position, drives the input gear of the gear train to drive the output gear of the gear train and drive the clutch element to impart movement of the output element and the cover panel;
wherein the clutch element, when the cover panel is manually moved between the closed position and the opened position, decouples the output element from the output gear of the gear train; and
wherein, with the output element decoupled from the output gear of the gear train, manual movement of the cover panel does not impart movement of the gear train.

2. The vehicular charge port closure system of claim 1, wherein, with the vehicular charge port closure system mounted at the vehicle, the cover panel is pivotably attached at the vehicle.

3. The vehicular charge port closure system of claim 2, wherein the cover panel pivots about a vertical pivot axis.

4. The vehicular charge port closure system of claim 2, wherein the cover panel pivots about a horizontal pivot axis.

5. The vehicular charge port closure system of claim 2, wherein the output element comprises an arcuate gear element, and wherein the clutch element comprises a gear portion that engages the arcuate gear element, and wherein, when the electrically operable motor is electrically operated and drives the input gear of the gear train, the output gear of the gear train drives the gear portion of the clutch element to impart movement of the arcuate gear element and the cover panel.

6. The vehicular charge port closure system of claim 5, wherein the clutch element comprises a pair of friction pads disposed between the gear portion of the clutch element and the output gear of the gear train, and wherein the pair of friction pads slip relative to one another to decouple the output element from the output gear of the gear train.

7. The vehicular charge port closure system of claim 1, wherein the output element comprises a receiver, and wherein the output gear of the gear train rotatably drives a threaded element that is received within a threaded portion of the receiver, and wherein the threaded element, when the electrically operable motor is electrically operated and drives the input gear of the gear train, drives the receiver to impart movement of the receiver and the cover panel.

8. The vehicular charge port closure system of claim 7, wherein rotational movement of the receiver relative to the threaded element is constrained, and wherein the receiver, when the threaded element drives the receiver, moves axially in a direction parallel to a longitudinal axis of the threaded element to move the cover panel between the closed position and the opened position.

9. The vehicular charge port closure system of claim 7, wherein axial movement of the receiver relative to the threaded element is constrained, and wherein the receiver, when the threaded element drives the receiver, pivots about a longitudinal axis of the threaded element to move the cover panel between the closed position and the opened position.

10. The vehicular charge port closure system of claim 1, wherein the output element comprises a linear gear, and wherein the output gear of the gear train engages the linear gear, and wherein the output gear, when the electrically operable motor is electrically operated and drives the input gear of the gear train, drives the linear gear to impart movement of the linear gear and the cover panel.

11. The vehicular charge port closure system of claim 1, wherein the cover panel comprises a first panel and a second panel, and wherein, when the cover panel is in the closed position, the first panel and the second panel each respectively extend partially over the charge port of the vehicle, and wherein, when the cover panel is in the opened position, the first panel is moved in a first direction away from the second panel and the charge port and the second panel is moved in a second direction away from the first panel and the charge port, and wherein the second direction is opposite the first direction.

12. The vehicular charge port closure system of claim 11, wherein the output element comprises a first linear gear coupled to the first panel and a second linear gear coupled to the second panel, and wherein, when the actuator is electrically operated to move the cover panel between the closed position and the opened position, the first linear gear and the second linear gear are moved together and in opposite directions relative to one another.

13. The vehicular charge port closure system of claim 12, wherein the output gear comprises a first output gear that is driven to impart movement of the first linear gear and a second output gear that is driven to impart movement of the second linear gear.

14. The vehicular charge port closure system of claim 13, wherein, when the actuator is electrically operated to move the cover panel between the closed position and the opened position, the input gear of the gear train drives a belt coupled to the first output gear and the second output gear to drive the first output gear and the second output gear.

15. The vehicular charge port closure system of claim 1, wherein the cover panel comprises a pin received at a channel of the vehicle, and wherein, when the cover panel moves between the closed position and the opened position, the pin moves within the channel to guide movement of the cover panel relative to the charge port and a side of the vehicle at which the charge port is located.

16. The vehicular charge port closure system of claim 15, wherein, when the cover panel moves from the closed position toward the opened position, the cover panel moves at least partially inward toward the charge port and the side of the vehicle.

17. The vehicular charge port closure system of claim 1, wherein the cover panel is pivotally attached at a first end of a pivot arm, and wherein a second end of the pivot arm opposite the first end is pivotally attached at the vehicle, and wherein, when the cover panel is moved between the closed position and the opened position, the cover panel moves in an arcuate path of motion, and wherein the cover panel pivots relative to the first end of the pivot arm and the second end of the pivot arm pivots relative to the vehicle to accommodate movement of the cover panel in the arcuate path of motion.

18. The vehicular charge port closure system of claim 1, wherein the cover panel is movably attached at a base portion at the vehicle, and wherein, with the cover panel in the opened position, a flexible sheet extends between the base portion and an edge region of the cover panel, and wherein, with the cover panel in the closed position, the flexible sheet flexes and is accommodated between the cover panel and the base portion.

19. The vehicular charge port closure system of claim 1, wherein the vehicle comprises one selected from the group consisting of (i) an electric vehicle and (ii) a plug-in hybrid vehicle.

20. A vehicular charge port closure system, the vehicular charge port closure system comprising:
a cover panel pivotally attached at a vehicle equipped with the vehicular charge port closure system, wherein the cover panel is pivotable between (i) a closed position, where the cover panel conceals a charge port of the vehicle, and (ii) an opened position, where the cover panel is moved away from the charge port to allow access to a charging connector of the charge port;
wherein the vehicle comprises one selected from the group consisting of (i) an electric vehicle and (ii) a plug-in hybrid vehicle;
an actuator that is electrically operable to move the cover panel between the closed position and the opened position;
wherein the actuator comprises (i) an electrically operable motor operable to rotatably drive an input gear of a gear train, (ii) an output element coupled to the cover panel and (iii) a clutch element coupled to the output element and to an output gear of the gear train;
wherein the output element comprises an arcuate gear element, and wherein the arcuate gear element, as the cover panel moves between the closed position and the opened position, moves together and in tandem with the cover panel;
wherein the clutch element comprises a gear portion that engages the arcuate gear element, and wherein the electrically operable motor, when the actuator is electrically operated to move the cover panel between the closed position and the opened position, rotatably drives the input gear of the gear train to drive the output gear of the gear train and drive the gear portion of the clutch element to impart movement of the arcuate gear element and the cover panel;
wherein the clutch element, when the cover panel is manually moved between the closed position and the opened position, decouples the arcuate gear element from the output gear of the gear train; and
wherein, with the arcuate gear element decoupled from the output gear of the gear train, manual movement of the cover panel does not impart movement of the gear train.

21. The vehicular charge port closure system of claim 20, wherein the clutch element comprises a pair of friction pads disposed between the gear portion of the clutch element and the output gear of the gear train, and wherein the pair of friction pads slip relative to one another to decouple the arcuate gear element from the output gear of the gear train.

22. The vehicular charge port closure system of claim 20, wherein the cover panel is pivotally attached at a base portion at the vehicle, and wherein, with the cover panel in the opened position, a flexible sheet extends between the base portion and an edge region of the cover panel, and wherein, with the cover panel in the closed position, the flexible sheet flexes and is accommodated between the cover panel and the base portion.

23. The vehicular charge port closure system of claim 20, wherein the vehicle comprises one selected from the group consisting of (i) an electric vehicle and (ii) a plug-in hybrid vehicle.

24. A vehicular charge port closure system, the vehicular charge port closure system comprising:
a cover panel disposed at a vehicle equipped with the vehicular charge port closure system, wherein the cover panel is movable between (i) a closed position, where the cover panel conceals a charge port of the vehicle, and (ii) an opened position, where the cover panel is moved away from the charge port to allow access to a charging connector of the charge port;
wherein the cover panel comprises a pin received at a channel of the vehicle, and wherein, when the cover panel moves between the closed position and the opened position, the pin moves within the channel to guide movement of the cover panel relative to the charge port and a side of the vehicle at which the charge port is located;
an actuator that is electrically operable to move the cover panel between the closed position and the opened position;
wherein the actuator comprises (i) an electrically operable motor operable to drive an input gear of a gear train, (ii) an output element coupled to the cover panel and (iii) a clutch element coupled to the output element and to an output gear of the gear train;
wherein the output element comprises a linear gear, and wherein the output gear of the gear train engages the linear gear, and wherein the linear gear, as the cover panel moves between the closed position and the opened position, moves together and in tandem with the cover panel;
wherein the electrically operable motor, when the actuator is electrically operated to move the cover panel between the closed position and the opened position, drives the input gear of the gear train to drive the output gear of the gear train and drive the clutch element to impart movement of the linear gear and the cover panel;
wherein the clutch element, when the cover panel is manually moved between the closed position and the opened position, decouples the linear gear from the output gear of the gear train; and
wherein, with the linear gear decoupled from the output gear of the gear train, manual movement of the cover panel does not impart movement of the gear train.

25. The vehicular charge port closure system of claim 24, wherein the cover panel comprises a first panel and a second panel, and wherein, when the cover panel is in the closed position, the first panel and the second panel each respectively extend partially over the charge port of the vehicle, and wherein, when the cover panel is in the opened position, the first panel is moved in a first direction away from the second panel and the charge port and the second panel is moved in a second direction away from the first panel and the charge port, and wherein the second direction is opposite the first direction.

26. The vehicular charge port closure system of claim 25, wherein the linear gear comprises a first linear gear coupled to the first panel and a second linear gear coupled to the second panel, and wherein, when the actuator is electrically operated to move the cover panel between the closed position and the opened position, the first linear gear and the second linear gear are moved together and in opposite directions relative to one another.

27. The vehicular charge port closure system of claim 26, wherein the output gear comprises a first output gear that is driven to impart movement of the first linear gear and a second output gear that is driven to impart movement of the second linear gear.

28. The vehicular charge port closure system of claim 27, wherein, when the actuator is electrically operated to move the cover panel between the closed position and the opened position, the input gear of the gear train drives a belt coupled to the first output gear and the second output gear to drive the first output gear and the second output gear.

29. The vehicular charge port closure system of claim 24, wherein, when the cover panel moves from the closed position toward the opened position, the cover panel moves at least partially inward toward the charge port and the side of the vehicle.

30. The vehicular charge port closure system of claim 24, wherein the vehicle comprises one selected from the group consisting of (i) an electric vehicle and (ii) a plug-in hybrid vehicle.
